(19) United States
(12) Patent Application Publication
(10) Pub. No.: US 2015/0324546 A1
(43) Pub. Date: Nov. 12, 2015

(54) METHOD FOR PREDICTING DRUG-TARGET INTERACTIONS AND USES FOR DRUG REPOSITIONING

(71) Applicant: GEORGETOWN UNIVERSITY, Washington, DC (US)

(72) Inventors: Sivanesan Dakshanamurthy, Herndon, VA (US); Stephen W. Byers, Tacoma Park, MD (US)

(21) Appl. No.: 14/408,316

(22) PCT Filed: Jun. 21, 2013
(86) PCT No.: PCT/US13/47152

§ 371 Date: Dec. 16, 2014

Related U.S. Application Data
(60) Provisional application No. 61/662,696, filed on Jun. 21, 2012.

(51) Int. Cl. G06F 19/00

(52) U.S. Cl. CPC G06F 19/3456

(57) ABSTRACT

Described herein are methods of predicting drug-target interactions and method of using the information for drug repurposing. The methods described herein combine different descriptors including, for example, shape, topology and chemical signatures, physico-chemical functional descriptors, contact points of the ligand and the target protein, chemical similarity, and docking score.

### CROSS-REFERENCES TO RELATED APPLICATIONS

The present application claims priority from and is a nonprovisional application of U.S. Provisional Application No. 61/662,696, entitled “Method For Predicting Drug-Target Interactions And Uses For Drug Repositioning” filed Jun. 21, 2012, the entire contents of which are herein incorporated by reference for all purposes.

### STATEMENT AS TO RIGHTS TO INVENTIONS MADE UNDER FEDERALLY SPONSORED RESEARCH AND DEVELOPMENT

This invention was made with government support under grant numbers R01-CA129813, R01-DK58196, P01CA130821, and 1KL2RR031974 and NIH Contract No. HHSN261200800001E, awarded by the National Institutes of Health, and grant numbers BC062416-01 and W81XWH-10-1-0437 awarded by the Department of Defense. The government has certain rights in the invention.

### BACKGROUND

Traditional methods of drug discovery face formidable scientific and regulatory obstacles resulting in the passage of many years and many failures from the discovery of a target to the clinical application of a novel patentable drug designed to inhibit or activate its function. There has been a marked decline in the willingness of the pharmaceutical industry to invest in drug discovery programs. With the emergence of systems biology approaches many more new drug targets have been identified and validated. However, drug development for these new targets can be time consuming and prohibitively expensive, leading to the concept of drug repositioning in which existing approved compounds are repurposed for another target/disease. There are clear advantages to this approach, including a dramatic reduction in time, expense, and safety concerns.

A number of existing approved drugs can serve as effective therapies for diseases other than those for which they were approved. Recently, the National Institutes of Health (NIH) has emphasized the importance of drug repositioning and deposited more than 27,000 active pharmaceutical ingredients in the Chemical Genomics Center (NCGC) database to encourage public screening. To date, screening is usually achieved by high throughput chemical screening or transcriptome matching. Other methods include phenotypic screening, protein-protein interaction assays, drug annotation technologies, high-throughput screening using cell-based disease models, gene activity mapping, ligand-based cheminformatics approaches, and in vivo animal models of diseases. However, experimentally testing all approved drugs against all targets is extremely expensive, as well as technically unrealizable.

An additional challenge of these screening studies is that after one gets a “hit,” the rational mechanism of action must still be deduced and tested. To address this, computational approaches based on drug regulated gene expression, side effect profile, and protein or chemical similarity, have been developed. Using high performance computing, high-throughput computational drug-target docking and screening are now also feasible. However, current methods are only able to predict a rough estimation of the free energy of binding and further suffer from high false positive and low rates of drug-target association prediction.

It is therefore desirable to provide new computational systems and methods to more accurately identify drugs that have a high interaction with targets.

### BRIEF SUMMARY

Described herein are methods of predicting drug-target interactions and methods of using the information for drug repurposing. Embodiments described herein can combine different descriptors including, for example, shape, topology and chemical signatures, physico-chemical functional descriptors, contact points of the ligand and the target protein, chemical similarity, and docking score to identify a ligand that interacts with a target.

Other embodiments are directed to systems and computer readable media associated with methods described herein. The details of one or more embodiments are set forth in the description below. Other features, objects, and advantages will be apparent from the description and from the claims.

A better understanding of the nature and advantages of embodiments of the present invention may be gained with reference to the following detailed description and the accompanying drawings

### BRIEF DESCRIPTION OF THE DRAWINGS

FIG. 1 is a flowchart of a method 100 for identifying protein-drug interactions according to embodiments of the present invention.

FIG. 2 is a graphical summary of modules that may be used in embodiments of the present invention.

FIG. 3A shows the accuracy of the TMFS method represented by ROC curves. FIG. 3B shows the validation of predicted drug-target associations for FDA approved drugs.

FIG. 4 shows a tabular depiction of PDB IDs within the protein target collection that correspond to protein targets found in the Directory of Useful Decoys (DUD).

FIG. 5 shows raw score values for each descriptor and Z-rank score for protein targets that were considered to be the Top 1 hit for staurosporine (DB2010) according to embodiments of the present invention.

FIG. 6A is a principle Component Analysis (PCA) of individual protein- and ligand-based descriptor variables for determination of descriptor correlation with obtaining reliable predictions. FIG. 6B shows a three-dimensional PCA plot of transformed eigenvalue coefficients of the aforementioned descriptor variables against the first three principal components.

FIGS. 7A-7C contains an analysis of FDA Drug-Target Association.

FIG. 8 shows a table of predicted drug-target associations in terms of drug frequency propensity for each target.

FIGS. 9A-9C shows an analysis of FDA blockbuster drug-target association. (A) Heatmap depicting hit frequencies of the Top 200 “blockbuster” FDA drugs across each top-rank category. Each box shows the number of occurrences while the color scheme illustrates high frequencies as red and low frequencies as blue. (B) Heatmap showing FDA approved drugs predicted to hit the greatest number of protein targets: Sutent, Alimta, Lescol, Celebrex, Premarin, Zetia, and Blopress. (C) Heatmap portraying FDA approved drugs that have no hits in the protein dataset: Prograf, Valcote, Concerta, Sifrol, Niaspan, Exelon, Evodart, Sevorane, and Klacid. (D) Histogram showing the percentage of total protein targets in the data set that have a FDA Blockbuster Drug in their Top 1, 5 and 20 rank lists.

FIG. 10 contains an analysis of drug promiscuity.

FIG. 11A shows a table of specific protein folds of targets that tmfs predicted for the top five most promiscuous drugs. FIG. 11B shows a table of specific protein families of targets that tmfs predicted for the top five most promiscuous drugs.

FIGS. 12A-12D show that similarly-shaped protein binding pockets bind similar molecules.

FIGS. 13A-13C demonstrate that Mebendazole binds directly to VEGFR2 kinase assay and also inhibits angiogenesis.

FIGS. 14A-14C show that Celecoxib (CCB) and Dimethyl-celecoxib (DMC) bind directly to immobilized cadherin-1 (CDH11) in Surface Plasmon Resonance (SPR) assay.

FIGS. 15A and 15B show the growth inhibition of MDA-MB-231 invasive breast cancer cell line by celecoxib (CCB) and its COX-2 inactive analogue dimethyl-celecoxib (DMC).

FIG. 16 shows a block diagram of an example computer system 1600 usable with system and methods according to embodiments of the present invention.

### DETAILED DESCRIPTION

Described herein are methods for predicting drug-target interactions, such as, for example, the molecule of best fit for a target. Embodiments can provide a comprehensive prediction method, which may collectively be called “Train-Match-Fit-Streamline” (TMFS), that can reduce false positive predictions and enrich for the highest confidence drug-target interactions. Previous studies screened FDA drugs using either chemical similarity or docking with stringent scoring criteria. In contrast, embodiments described herein can combine different descriptors including, for example, shape, topology and chemical signatures, physico-chemical functional descriptors, contact points of the ligand and the target protein, chemical similarity, and docking score. Descriptors can be trained with template knowledge; match and fit of the signatures identified; and the data stream lined.

Some embodiments can be receptor-centric (i.e., focuses on the target receptor). Other embodiments can be ligand-centric (i.e., focuses on ligands). Potential drug-target interactions are predicted with accuracy. For example, embodiments can predict drug-target associations with greater than 80% accuracy (e.g., greater than 85% accuracy or greater than 90% accuracy, such as 91% accuracy) for the majority of drugs.

Embodiments can be used to identify new uses for known drugs (i.e., drug repositioning). Methods can include identifying interactions of drugs with one or more proteins that can be a target for treating a disease or disorder. In identifying the interaction, the drug can be predicted as a treatment for a disease or disorder. In this way, the drug will be identified as a new use for a known drug. Optionally, methods can include computationally obtaining and processing three-dimensional protein structures, computationally docking a drug into the protein structure, generating and quantifying receptor and ligand descriptors, quantifying the receptor and ligand descriptors, and calculating a comprehensive score according to the following equation:

$${Z}_{l , p} = {ω}_{k} Y ( {σ}_{p} , {σ}_{l} ) + {\sum }_{m = 1}^{M} [ {ω}_{m} {f}_{m} ( {σ}_{p} , {σ}_{l} ) + {ω}_{m}^{′} {f}_{i}^{′} ( {σ}_{c} , {σ}_{l} ) ] + {\sum }_{n = 1}^{N} {X}_{n} ( {σ}_{c} , {σ}_{l} ) + {CS ( O L I C )}_{l , p} ,$$

where the comprehensive score can indicate the degree of protein-drug interaction. In some examples, the comprehensive score can be used to determine the fit of the drug. Various embodiments can exclude one or more terms from the above equation when calculating the score.

Optionally, the descriptors can include one or more (e.g., two or more, three or more, four, or five or more) of shape, topology signatures, physico-chemical functional descriptors, contact points of the ligand and the protein, chemical similarity, and docking score.

Optionally, embodiments for predicting the new use for the known drug can be enhanced by using information obtained by querying a database with data obtained from other methods for identifying drug targets. Novel analogues of the known drug can be developed to treat diseases and disorders associated with the identified drug target.

### I. Predicting Drug-Target Interactions

The prediction function used to determine the Z score (ligand-target interaction score) can be trained from a set of ligands and proteins. In one embodiment, proteins that have a known binding complex with a reference ligand are used. The prediction function can then be applied to a new ligand and a new protein, where a binding complex of the new protein with a reference ligand may be known.

For a particular ligand and target combination, the prediction function provides a Z score (interaction score) that indicates a likelihood of an interaction existing. With the Z score is above a threshold, the interaction can be identified as existing. In one embodiment, the threshold can be determined based on a collection of Z scores for various ligand-target combinations. For example, once you have the Z scores, one can determine whether or not the ligand (drug) is suitable for this target, i.e., whether or not there is a significant interaction, and thus the interaction exists. Thus, the threshold can be a relative threshold, such as a ranking (e.g., top N Z scores of a set or top percentage of a set). An absolute threshold for the Z score may be used, e.g. 0.7 with the Z scores normalized to be between 0 and 1.

The training can use a set of known drugs and targets and can determine normalizing weights for various terms. Data is provided below to show validation of the interaction prediction function. Thus, the prediction function can be applied for a new drug-target interaction. The targets can be ones identified to achieve an interaction or can be ones identified to make sure that there are no side effects.

A. Equation

The interaction prediction function can identify ligands of best fit. The prediction function can be part of “Train-Match-Fit-Streamline” (TMFS) procedure. In some embodiments, the interaction prediction function is provided as:

$${Z}_{l , p} = {ω}_{k} Y ( {σ}_{p} , {σ}_{l} ) + {\sum }_{m = 1}^{M} [ {ω}_{m} {f}_{m} ( {σ}_{p} , {σ}_{l} ) + {ω}_{m}^{′} {f}_{i}^{′} ( {σ}_{c} , {σ}_{l} ) ] + {\sum }_{n = 1}^{N} {X}_{n} ( {σ}_{c} , {σ}_{l} ) + {CS ( O L I C )}_{l , p} , \qquad ( 1 )$$

σₚ corresponds to structural/chemical information of the protein. σₗ corresponds to structural/chemical information of the test ligand (e.g., possible drug for target). σ_{c} corresponds to structural/chemical information of the reference ligand (i.e., ligand that is known to bind to the protein). σ_{c} can be determined from crystallography data of the protein with the reference ligand. For example, an x-ray can be taken of a complex of particular protein combined with the reference ligand. Thus, the reference ligand can be extracted from a known crystal (e.g., obtained from RCSB) that represents a natural bioactive conformation. σ_{c} can serve as a point of comparison for the shape and chemical descriptors of σₗ. In one aspect, the identities of σₚ, σ_{c} and σₗ (protein, reference ligand crystal structure for that protein, and probe molecule, respectively), are constant across all terms of the equation.

The ‘Y’ term represents a docking score of a test ligand (σₗ) with a pocket of a particular protein (σₚ), along with its designated weight (ωₖ). The pocket can be defined by the reference ligand. The docking score typically is not comparable with the other scores (e.g., the docking scores typically negative). The designated weight is used for normalization with respect to other terms. Software application, such as Schrodinger, can be used. The docking score can identify whether or not the test ligand the protein would structurally bind.

The first summation term is a shape term that has M shape contributions to a shape score, each shape contribution corresponding to a different shape descriptor. Each contribution has two parts. Each index m can correspond to a different shape descriptor. M can be 1 for a shape descriptor of the normalized Euclidean distance.

The first part corresponds to wₘƒₘ(σₚ, σₗ), where f is a first shape function for the mth shape descriptor. This first shape function corresponds to a shape of a pocket of the protein and the test ligand. A weighting factor ωₘ can be used for normalization. In one embodiment, the first shape function represents a normalized Euclidean distance scores between the protein pocket and the test ligand. In one implementation, σₚ represents only the protein pocket in a natural bioactive state that was crystallized with the reference ligand σ_{c}, and a comparison can be made between the potential shape of test ligand σₗ to the bioactive pocket σₚ.

The second part of each contribution of the shape term corresponds to ω′ₘƒ′ᵢ(σ_{c}, σ₁), where ƒ′ is a second shape function (which may be the same as the first shape function) for the mth shape descriptor. This second shape function corresponds to a shape of the reference ligand σ_{c} and the test ligand σₗ. A weighting factor ω′ₘ can be used for normalization. In one embodiment, the second shape function represents a normalized Euclidean distance scores for the reference ligand and the test ligand.

The normalization weights ωₘ and ω′ₘ can vary for each shape descriptor, be the same for each shape descriptor, and can be different between the values for the same shape descriptor. Examples of shape descriptors are shape, volume, and solvent-accessible surface area (SASA). In various embodiments, the corresponding weights for shape may be higher than the corresponding weights for volume (or vice versa), as the shape may be more indicative of an interaction.

With respect to the second shape function, an assertion that can underlie this function is that the reference ligand σc does not necessarily adopt a shape that is completely complementary to the shape of the pocket σp. However, given that σc is co-crystallized with σp, it can be inferred that the shape of σc is a bioactive conformation regardless of the extent of shape complementarity to σp. Hence, the second shape function can be a further refinement wherein the shape of test ligand σₗ is compared to that of σc, which can correct for a potential lack of shape complementary between σₗ and σp.

The second summation term is a similarity term that has N contributions, each similarity contribution corresponding to a different similarity descriptor. In one embodiment, N equals eight. The similarity descriptors may be physicochemical descriptors. The similarity score function Xₙ(σ_{c}, σₗ) for the nth similarity descriptor provides a similarity score between an nth similarity function of the test ligand and an nth similarity function of the reference ligand. Example outputs of a similarity function are solvent-accessible surface area (SASA) or number of rotatable bonds (Rotor). The number of rotatable bonds can be compared between the test ligand and the reference ligand. In one embodiment, normalized Tanimoto or Manhattan scores can be determined for the similarity scores.

The fourth term CS(OLIC)_{l,p} is a correct term that relates to a difference between the contact points of the test ligand and the protein in the contact points of the reference ligand with the protein. The correction term is for the lth test ligand and the pth protein.

B. Method

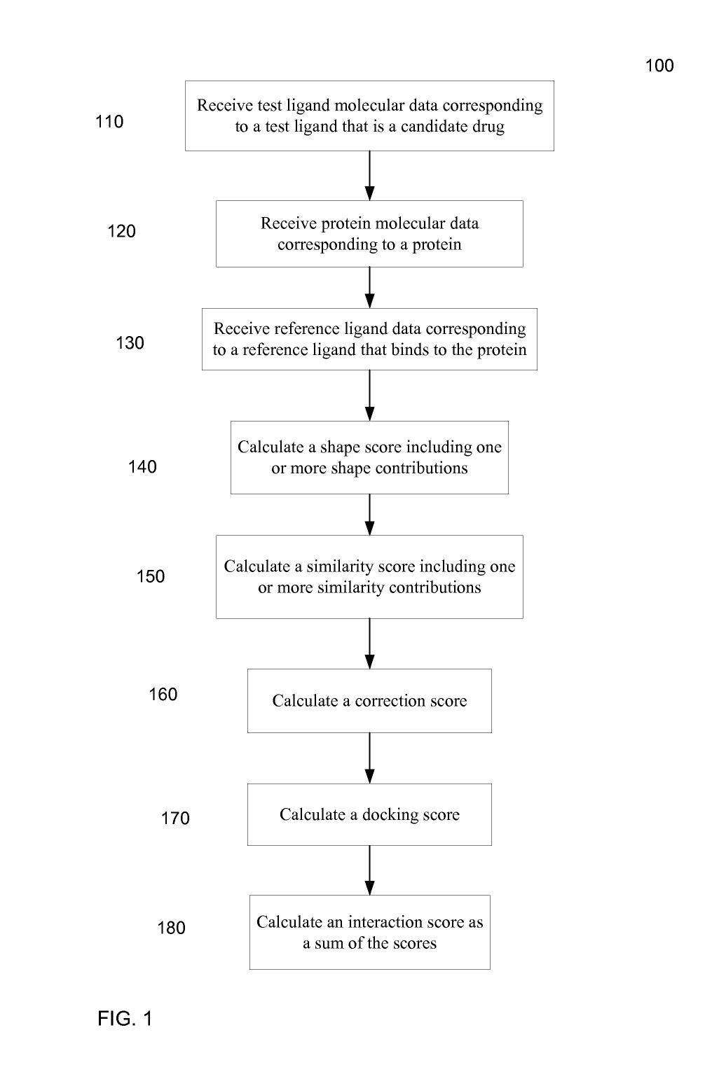

FIG. 1 is a flowchart of a method 100 for identifying protein-drug interactions according to embodiments of the present invention. Method 100 may be performed with a computer system. Various scores calculated in method 100 may be optional.

At block 110, test ligand molecular data corresponding to a test ligand that is a candidate drug is received. The test ligand molecular data can include physical information about bonds and atoms of the test ligand, chemical information such as solvent information, electrostatic information such as a dipole.

At block 120, protein molecular data corresponding to a protein is receiving. The protein molecular data can include three-dimensional protein structures of the protein. As other examples, physical and electrostatic information can also be received.

At block 130, reference ligand data corresponding to a reference ligand that binds to the protein is received. In one embodiment, at least some of the reference ligand data is obtained from a complex of the reference ligand bound to the protein. For example, x-ray information of a complex of the reference ligand bound to the protein can be received.

At block 140, a shape score including one or more shape contributions is calculated. For example, the first summation term in equation (1) can be calculated. Each shape contribution corresponds to a respective shape descriptor (e.g., shape, volume, etc.). A respective contribution (e.g., mth contribution) includes two parts. The first part provides a first shape score from a first respective shape function (e.g., ƒₘ(σₚ, σₗ)) of the protein and the test ligand corresponding to the respective shape descriptor. The second part provides a second shape score from a second respective shape function (e.g., ƒ′ᵢ(σ_{c}, σₗ)) of the reference ligand and the test ligand corresponding to the respective shape descriptor. The shape score can be determined as a sum of the respective first and second shape scores of the contribution(s).

At block 150, a similarity score including one or more similarity contributions is calculated. Each similarity contribution corresponds to a respective similarity descriptor (e.g., number of rotatable bonds or SASA). A respective similarity contribution provides a similarity score (e.g., determined by Xₙ(σ_{c}, σₗ)) between a respective similarity function of the test ligand (e.g., function providing SASA of test ligand) and the respective similarity function of the reference ligand (function providing SASA of reference ligand).

A principal component analysis can determine the most important descriptors for the shape and similarity descriptors. In some embodiments, only these most important descriptors are used. In one embodiment, descriptors for shape, volume, rotor (number of rotatable bonds), acceptHB (number of hydrogen-bond acceptors), have the most impact on the resulting interaction score.

At block 160, a correction score is calculated. The correction score can be a difference between two sums, where the first sum is of energies of contact points between the reference ligand and the protein and the second sum is of energies of contact points between the test ligand and the protein. The different contact points can have different energies, and be weighted differently.

At block 170, a docking score can be calculated. The docking score can be computed using techniques known to one skilled in the art. The docking score can be negative. A normalization factor can provide a docking score that is positive and between 0 and 1.

At block 180, an interaction score is calculated. The interaction score can include a sum of the shape score, the similarity score, and the correction score, as well as the docking score. The interaction score can be compared to a threshold to determine whether or not an interaction exists. For example, if the interaction score is above the threshold, an interaction can be identified as existing, since the level of binding is predicted to be high. The threshold may be a score value (e.g., 0.7). In another embodiment, a ranking of multiple interaction scores can be performed. Then, interaction scores above a certain rank. The rank can be determined as an absolute value, such as 10 or 40. The rank can also be determined as a percentage, e.g., in the top 10%.

### II. Various Terms

Further details that may be used in embodiments for calculating various terms of equation (1) are now described.

A. Grid Generation and Docking

For the generation of receptor grids for docking, the grids may be generated using Schrodinger's ‘Glide’ module. In one embodiment, grid center points were determined from the centroid of each protein's cognate ligand. To obtain the centroid, the Cartesian coordinates were extracted for each atom in the ligand and the average was taken for each dimension. To determine the size of the grids, a trial-and-error approach was used to determine the smallest grid size that would allow for the re-docking of all reference ligands. The largest reference ligand was chosen as the upper size limit, and it was found that a grid size of 20 Å on each side was the minimum to allow for it to dock. Thus, the grid size for docking simulations was set at 20 Å.

The prediction function may be trained from a set of drugs. In one implementation, the set of drugs may be created from an FDA-approved/investigational drugs data set. Since the FDA drugs prepared using LigPrep were energetically minimized, their final 3D shapes may deviate significantly from those of the reference ligands and their native binding pockets. In one embodiment, in order to predict more accurate poses, a unique conformer set of FDA drugs with respect to each protein was created. To do so, an “exhaustive” conformational search was performed, using Schrodinger's ConfGen module, for each drug to obtain a library of more than 100,000 conformers. The shape of each conformer, along with the active conformation of the reference ligands, was then calculated using the spherical harmonics expansion approach. Subsequently, shape similarities were quantified using the Euclidean distance metric between each reference ligand and all the drug conformers. The drug data set for docking was assembled by choosing the conformer for each drug whose shape had the smallest Euclidean distance to the shape of the reference cognate ligand for a given protein. Thus, each protein had a unique drug data set whose conformers more closely resembled the shape of that protein's reference ligand.

In some embodiments, the determination of a scoring function can be determined as follows using a positive docking control for choosing a scoring function. In one embodiment, because a large number of protein-ligand complexes needed to be scored, a scoring function in Glide docking program was sought that would give reasonable docking results most efficiently. To determine this, all the reference ligands were re-docked, with their crystal structure conformations conserved, to their native targets to confirm that their bioactive conformations were reproduced. The XP scoring method was chosen with a 10-pose post-minimization procedure to determine the final pose.

Reproducibility of the bioactive conformations was determined using visual inspection. That is, the PDB crystal structure reference containing the crystallized ligand was superimposed to the docking output confirmation. Upon superimposing, the positions of the crystallized ligand compared to the docking output ligand were visually inspected to note any deviations. From thorough inspection of 100 protein-ligand complexes, ˜70% of them were found to have reproduced the bioactive conformations. With this outcome, it was decided to proceed with the XP scoring function. Each unique FDA drug was docked to its respective protein using the aforementioned parameter options.

B. Shape Similarities

In some embodiments, to quantify shape similarity, the Euclidean distance metric was employed. Euclidean distances allowed for a fine-resolution comparison of ligand and pocket shapes through comparison of their spherical harmonics expansion coefficients, as well as the shape of multiple conformers for a single molecule. Equation 2 depicts the Euclidean distance function:

$$d ( \vec{a} , \vec{b} ) = \sqrt{{\sum }_{i = 0}^{n} {( {b}_{i} - {a}_{i} )}^{2}} \qquad ( 2 )$$

The smaller the Euclidean distance between two coefficients (vectors a and b having n=(1ₘₐₓ+1)²), the more similar they are with regards to shape. As a general rule, shapes are identical if the Euclidean distance is less than 3, similar if it is less than 5, and increasingly dissimilar if it is greater than 6. Other cutoff values may be used.

The ligand-to-ligand and ligand-to-pocket (protein binding site) Euclidean distance scores were normalized and implemented into the final ranking equation. Euclidean distances were also calculated for protein pocket-to-pocket shape comparisons, which were used for a binding-site similarity analysis outside of the “ligand of good fit” question.

C. Ligand-Based Descriptor Similarities

Since the approach in determining the “ligand of good fit” depends partially on the co-crystallized ligand, the similarities of the query molecules to the reference ligands were analyzed using the ligand-based descriptors (i.e., similarly descriptors), as described earlier. In one implementation, a QikProp module in Schrodinger was used to provide quantification of ligand-based descriptors, such as molecule globularity, which further allows for statistical similarity analysis. To do so, the Strike module in Schrodinger was used to calculate Tanimoto and Manhattan similarity scores for each probe molecule's descriptor value against all of the reference ligands. A Tanimoto score of 1.0 or a Manhattan score of 0.0 for a particular descriptor signifies that a given probe molecule is practically identical to the reference ligand based on that descriptor property. A discrepancy in the usage of Tanimoto or Manhattan scores is due to whether or not the variable at hand is continuous or discrete, respectively. These similarity scores were later normalized and substituted for the final ranking equation 8.

D. Ligand Interaction Correction Score

In one implementation, to obtain a better estimate of ligand interaction with protein on the reference binding site, another correction term was introduced called ‘optimal ligand interaction correction’ (OLIC), which assumes that ligands will have similar experimental activity if their interaction involves similar binding site residues, and makes similar interaction patterns to the reference ligand. The nature of the interactions and their interacting residue motifs are then input to the OLIC algorithm, which calculated a score for each reference and test set ligand contact point using, e.g., equations 3 and 4. The final contact point score was calculated using equation 5.

To be consistent with the other scores calculated above, the corrected score was normalized in the range of 0 to 1 using equations 3 and 4. If the corrected score is ‘0,’ then the test set ligand has a similar interaction pattern and similar activity, and is considered as the molecule of best fit when compared to the reference ligand. If the corrected score is ‘1’, then the test set ligand is considered as a non-binder.

In the determination of the binding site energies for the reference ligand and the protein, the following equation may be used:

$${S ( O L I C - R )}_{j} = {\sum }_{n = 1}^{NR} {ω}_{n} {E}_{n , j} \qquad ( 3 )$$

The sum is over the number of contact points NR between the protein and the reference ligand. For the training set used for examples herein, j runs from 1 to 2,335. In one aspect, there is only one reference ligand for each protein. The E_{n,j} corresponds to an energy for the nth contact point for the jth reference ligand-protein complex. A weighting factor specific to each contact point may be used. The weighting factor can also be dependent on the particular ligand-protein complex.

In the determination of the binding site energies for the test ligand and the protein, the following equation may be used:

$${S ( O L I C - T )}_{i , j} = {\sum }_{n = 1}^{NT} {ω}_{n} {E}_{n , i , j} \qquad ( 4 )$$

The sum is over the number of contact points NT between the protein and the test ligand. For the training set used for examples herein, i runs from 1 to 3,671 and j runs from 1 to 2,335. The E_{n,i,j} corresponds to an energy for the nth contact point for the ith test ligand and the jth protein. A weighting factor specific to each contact point may be used. The weighting factor can also be dependent on the particular test ligand-protein combination.

The correction term may be determined as a difference between the two sums:

CS(OLIC)_{i,j}=S(OLIC−R)ⱼ−S(OLIC−T)_{i,j} (5)

E. Normalization

As described above, normalization weights may be used to normalize between the various terms, and to normalize between contributions of a particular term. For example, a docking may be −20, but the shape descriptor terms and similarity descriptor terms may be positive. Thus, a normalization would be done. In one embodiment, the normalization provides values between 0 and 1 for each term.

In one embodiment, the docking scores, shape scores (e.g., Euclidean distance scores), and ligand-based descriptor similarity scores were normalized to create a common scoring scheme whose values ranged from 0 to 1, with 1 being either the most favorable docked conformation or greatest similarity based on the shape and ligand-based descriptors. Equations 6 and 7 depict schema they can be used for normalization according to embodiments:

$$\begin{matrix}N = \frac{x - min}{max - min} & ( 6 ) \\ N = 1 - \frac{x - min}{max - min} & ( 7 )\end{matrix}$$

Equation 6 was used for data whose best score was the maximum score (e.g., Tanimoto scores for ligand-based descriptors) while Equation 7 was used for data whose best score was the minimum score (e.g., docking scores where the most negative score is the best). The final normalized scores can be used in equation (1).

### III. Modules

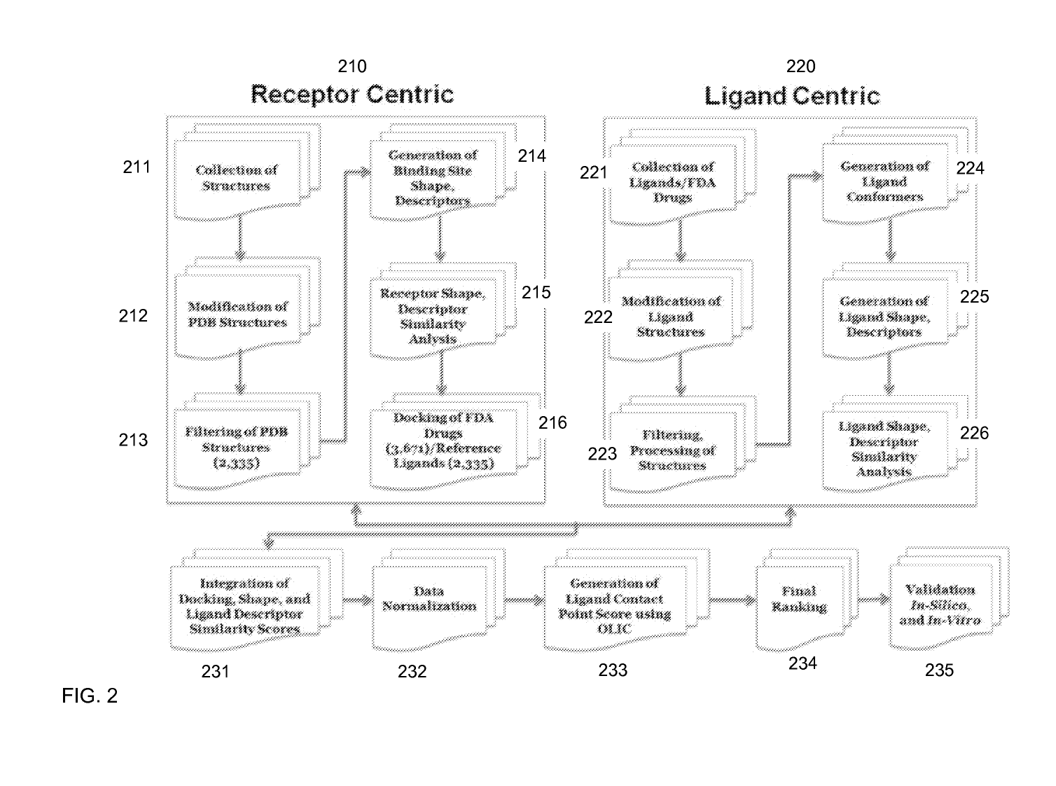

Modules usable by embodiments are outlined in FIG. 2, and the following sections detail each module. The modules are generally described as they relate to the training set for determining the interaction prediction function. Modules 210 correspond to the receptor (protein). Modules 220 correspond to the ligands.

A. Protein Target Collection, Processing, and Preparation

A protein collection module (211) can perform an extensive search (e.g., of the PDB database) with the following parameter filters to obtain Human PDB structures (holo structures): a) source organism: homo sapiens, b) macromolecule type: only contains protein/enzyme, c) has ligands: yes, d) experimental method: X-ray w/ experimental data, e) do not include proteins that have sequence similarity>90%. This filtered query resulted in 11,100 structures, which were subsequently downloaded. In the implementation described below, 11,000 x-ray 3D structures (human-liganded proteins) were collected from the PDB database.

Protein processing modules 212 and 214 may modify and filter protein structures, respectively. For example, the PDB structures can be filtered to eliminate structures that contained only metals or other ions noted without ligands. The retained set was further filtered by removing structures containing “modified residues” as ligands using a PERL script. Using another PERL script, the remaining protein PDB files were cleaned so that they contained only the correct chains, including those that are biologically relevant, interact with ligand, and contain all necessary cofactors. Next, the script was formatted as a list that contained the RCSB two- and three-letter codes corresponding to the cofactors and metals. These records were then searched against HETA™ lines for matches.

All matches were retained along with the corresponding CHAIN records, and non-matching HETA™ lines were deleted. The resulting modified PDB entries were devoid of all solvent molecules, salts, and non-cofactor ligands. A total of 2,335 modified PDB structures were subjected to virtual protein preparation. Modified PDB structures were converted into Schrodinger software native MAE format for protein preparation. The “protein prep” command line utility was used in a C-shell script to automate the process of adding explicit hydrogen atoms, fixing the correct protonated states and disulfide bonds.

B. Ligand Collection, Processing and Preparation

Module 221 can collect test ligands and reference ligands. Crystal structures of reference ligands and FDA-approved and experimental drug set collection can be obtained. For the set of protein structures obtained prior to the protein preparation procedure, the corresponding ligand crystal structures were gathered from the PDB database. These ligands served as template coordinates for receptor grid generation, a docking control, as well as references for the ligand-centric rescoring. To achieve this, a C-shell script was used that prepared a list of PDB IDs with their corresponding ligand three-letter codes and substituted the paired strings into a template hyperlink using the cURL command to retrieve the appropriate SDF files. This automation allowed for the retrieval of individual ligands that retained their bioactive conformation and coordinates with respect to each chain of the corresponding protein. FDA-approved and experimental drug structures were obtained from the Drug Bank, FDA, and BindingDB.

Modules 222 and 223 perform ligand processing. For reference ligand processing, the SDF files downloaded from the PDB database contained one or more instances of the ligand depending on whether or not the corresponding proteins were crystallized as multimeric structures. Since the PDB structures were processed such that only the biologically relevant chain is retained, the SDF files were processed so that each one contained only a single instance of the ligand that corresponds to the biologically active PDB chain. Using a PERL script, chain identifiers were extracted from the PDB files and used to match the ligand chain IDs. The resulting SDF files were then subjected to ligand preparation procedures using Schrodinger's LigPrep application.

Module 224 can generate ligand conformers. For reference ligands, since the reference ligand crystal structures were downloaded as three-dimensional structures in their bioactive conformations from the PDB database, the “applyhtreatment” command was used via a C-Shell script. This command allowed the conformations to be retained while adding hydrogen atoms and neutralizing the ligands for use in docking control, shape calculations, as well as the generation of ligand-based descriptors using Schrodinger's QikProp application.

For FDA-approved/investigational drugs (i.e. test ligands), molecules in their two-dimensional SDF format were first obtained. For conversion to three-dimensional energy-minimized structures and neutralization, a “ligprep” command was automated using a C-Shell script. This set of neutralized molecules was also subjected to QikProp descriptor generation. After neutralization, the neutralized structures were ionized at a pH of 7.0 using the “ionizer” utility to generate ionized states that retained the minimized conformations at physiological pH. These ionized structures were later used for shape calculations and docking.

Module 225 can determine the ligand shape descriptors ƒₘ(σₚ, σₗ) and ligand similarity descriptors, which correspond to ƒ′ᵢ(σ_{c}, σₗ). In one implementation, ligand descriptors for the ligand-centric descriptor similarity approach were calculated using Schrodinger's QikProp application. In one example, the following descriptors were computed for the reference ligands and FDA-approved drugs: (1) number of hydrogen-bond acceptors, (2) dipole moment, (3) number of hydrogen-bond donors, (4) electron affinity, (5) globularity, (6) molecular weight, (7) predicted log of the octanol/water partition coefficient (ClogP), (8) number of rotatable bonds (9) solvent-accessible surface area (SASA), and (10) volume. Globularity, SASA, and volume are examples of shape descriptors. Some descriptors, such as SASA, can be used as shape descriptors and/or similarity descriptors.

Module 226 can perform the calculations relating to these descriptors. For example, module 226 can perform part of block 140 and block 150 of method 100.

C. Shape Quantification: Ligand, and Protein Binding Pockets

Module 214 can determined binding site shape descriptors. Shape descriptors for the ligand, and protein binding pockets were generated using a Java software package provided by the Thornton group. The spherical harmonics expansion approach was used to describe the shape of ligands as well as binding sites using protomol information of those sites obtained from the sc-PDB database. For PDB files missing in sc-PDB, the protomols were computed using SurFlex Protomol generator within SYBYL X.1 (Tripos International, St. Louis, Mo. USA). Binding site protomols were stripped of all atoms except hydrogen and carbon so that the final pocket shape was as refined as possible. The methodological application of the expansion with real spherical harmonic functions was performed to approximate the surface function. Equation 8 shows the function for the spherical harmonics shape calculations.

$$f ( θ , ϕ ) = {\sum }_{l = 0}^{∞} {\sum }_{m = - 1}^{l} {c}_{l m} {y}_{l m} ( θ , ϕ ) \qquad ( 8 )$$

Module 215 can perform the calculations relating to the binding site descriptors. For example, module 215 can perform part of block 140. Module 216 can perform the docking calculations, e.g., as performed in block 170.

D. Interaction Score and Normalization

Module 231 can combine the scores from modules 215, 216, and 226. Module 232 can then reform the data normalization, e.g., as described herein. Module 233 can calculate the correction score, e.g., as in block 160 of method 100 and as described herein. Module 233 can provide the final interaction score. Module 234 can perform a ranking other interaction scores, for embodiments that use ranking. Module 235 can perform a validation, as is described below.

### IV. Validation

This section describes the process of validating results for a prediction function corresponding to an embodiment. The final ranking of protein target-ligand complexes was based on 1 total descriptors, 8 of which are solely ligand-based. In order to reduce this bias, weights were provided to the protein-oriented descriptors (i.e. docking score and protein shape), as well as to the ligand shape score since the shape parameters can be more accurate approximations of the true protein-ligand interactions. The weights of 4, 2 and 2 for docking, protein shape and ligand shape scores, respectively, provided the final ranking equation with a good balance among the descriptors that led to the accurate predictions noted in FIG. 2B. The embodiment validated was a sum of all the terms in equation (1), providing a comprehensive TMFS Z-score for a single ligand with respect to a protein that takes into account, receptor-centric features (e.g., docking score), ligand-centric nonstructural descriptors (e.g., QikProp descriptors from Schrodinger) and shape-based features (protein pocket-ligand and ligand-ligand).

As will be explained in the Results section, a proper validation of the TMFS predictions across our large protein target data set (2,335 targets) using the currently available literature poses many challenges. In order to account for these challenges, the following equation was devised to calculate the percent correctly predicted (PCP) targets:

$$P C P = {\sum }_{l = 1}^{∞} ( \frac{n {A}_{ji} + {nB}_{ji} + {nY}_{ji}}{{nB}_{ji} + {nX}_{ji} + {nY}_{ji} + {nZ}_{ji} - {nE}_{ji}} ) \times 100 \\ where i = 3 , 671 , j = 2 , 335 , \qquad ( 9 )$$

where “n” represents total number of targets; “A, B, Y, B, X, Y, Z and E” represent targets; “Aⱼᵢ” is the number of predicted targets “j” for drug “i”; “Bⱼᵢ” is the number of experimentally validated targets “j” for drug “i”; “Xⱼᵢ” is the number of correctly predicted targets “j” from this experiment results for drug “i”; “Yⱼᵢ” is the number of targets not validated experimentally within the predicted lists for drug “i”; “Zⱼᵢ” is the number of experimentally validated targets “j” for drug “i” which are not included in the target data set; and “Eⱼᵢ” number of experimentally validated targets “j” for drug “i” that were not target hits but are included in the target data set.

### V. Results

The in-silico screening of 3,671 FDA approved and investigational drugs across 2,335 protein structures was performed using an embodiment described herein. The embodiment led to the identification of known drug-target interactions with remarkable accuracy, and experimentally confirmed new activities for two well-known drugs.

Over 58% of the known best ligands for each target were correctly predicted as top ranked, followed by 66%, 76%, 84% and 91% that these agents ranked in the top 10, 20, 30 and 40 respectively out of all 3,671 drugs respectively. Drugs ranked in the top 1-40, but which are not experimentally validated for a particular target now become candidates for repositioning. The TMFS method described herein was used to discover that mebendazole, an anti-parasitic with recently discovered and unexpected anti-cancer properties, has the structural potential to inhibit VEGFR2. It was confirmed experimentally that mebendazole inhibits VEGFR2 kinase activity, as well as angiogenesis, at doses comparable with its known effects on hookworm. The TMFS method described herein also predicted, and was confirmed with surface plasmon resonance, that dimethyl celecoxib and the anti-inflammatory agent celecoxib, can bind cadherin-11, an adhesion molecule important in rheumatoid arthritis and poor prognosis malignancies—for which no targeted therapies exist.

In the receptor centric approach, ˜11,000 x-ray 3D structures (human-liganded proteins) were collected from the PDB database. After filtering (see methods above for details), 2,335 unique protein structures were included for the receptor-and-ligand centric simulations. 3,671 FDA approved and clinical trial drugs, as reported in the DrugBank, BindingDB, and FDA.org, were docked. Given that an important factor in determining a molecule of “good fit” is the similarity of its shape to those of the bioactive conformation of the reference ligand and ligand binding pocket, receptor and ligand shape descriptors and similarity quantification were integrated into TMFS scoring.

To quantify a molecule's shape similarity, the Euclidean distance metric was employed. Binding pocket, ligand shape using sc-PDB was calculated within the protein, shapes of the ligands (reference ligands and drugs) using ScPDB, and SurFlexDock Protomol generator within SYBYL X.1, and a shape similarity analysis was performed. The docking, shape, and ligand descriptor similarity score data was then collected and integrated. Independently, the ligand-protein contact point scores were calculated using the ‘OLIC’ method. Each data set score was normalized between 0 and 1. Then, using equation 8, a final ranking score was computed, the comprehensive TMFS score ‘Z’ that gives molecules of“good fit”.

A. Analysis of Accuracy of the TMFS Method Using ROC

The precision of the TMFS method was examined to see if it substantially enriches the number of active compounds detected at the top of the ranking list. Since the study involved 2,335 unique proteins, and 3,671 drugs, the docked output has ˜8.4 million protein-ligand complexes for each docking protocol. The TMFS method was applied in conjunction with the most efficient docking algorithm to produce reliable results in the quickest time possible. To do this, a database of actives and decoys for estrogen receptor alpha (ERα) was obtained from the DUD, which contains ˜3,000 compounds. The computational prediction protocol was then performed on the crystal structure of the agonist conformation of estrogen receptor (PDB ID: 3ERD) to determine if the method significantly enriches the number of known active compounds within the top 20 positions derived from the TMFS method described herein as compared to the options provided solely in the Schrodinger software.

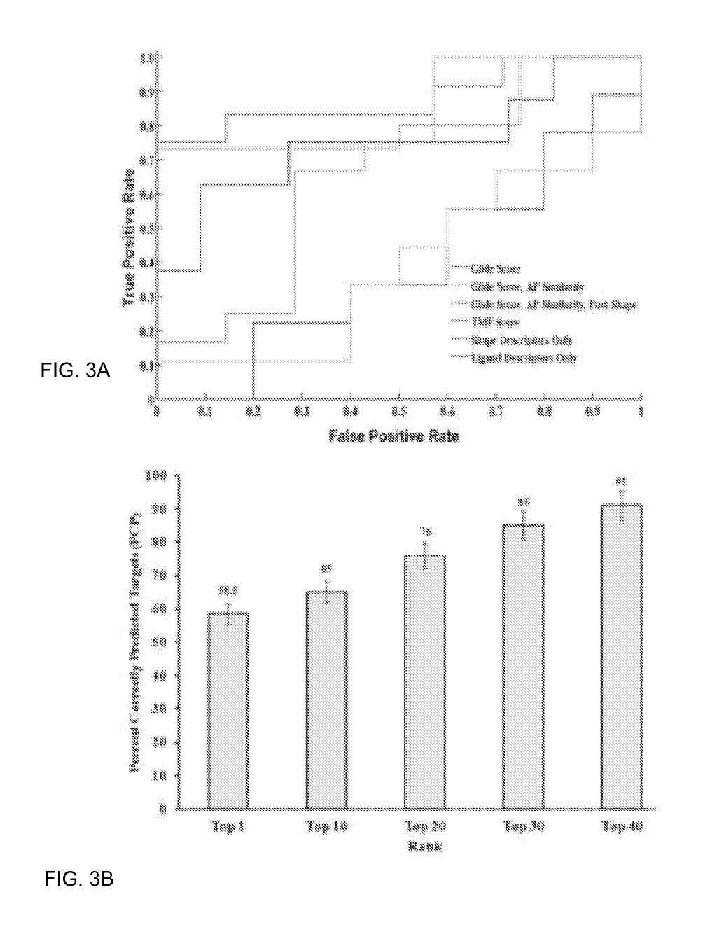

FIG. 3A shows the accuracy of the TMFS method represented by ROC curves. In increasing order of enrichment of true bioactive compounds, the performance of each scoring method via their respective AUC is shown: Glide score (0.3889; red), Glide score+atom pair (AP) similarity (0.3889; yellow), shape descriptors only (0.6905; teal), ligand-centric descriptors only (0.7500; blue), Glide score+AP similarity+Post-Shape (0.8167; green), and TMFS score (0.8810; purple).

First, simple docking was performed as the control. The Glide docking score yielded a high false positive rate. The procedure was repeated with the “atom-pair similarity” of the probe ligands. This procedure re-ranks docked compounds according to their atom-pair similarity to a template ligand, in this case the co-crystallized ligand in its active conformation. The conformers of the probe molecules in these two steps were only the minimized structures from the LigPrep application. As shown in FIG. 3A, atom-pair similarity re-ranking did not provide significant enrichment over the pure Glide docking score. Next was to determine if choosing probe molecule conformers whose shapes most closely matched to that of the reference ligand would result in greater enrichment.

An exhaustive conformer library for each drug was prepared and the conformer whose shape most closely matched that of the active conformation of the crystallized ligand for each protein was chosen. With the new, individualized “conformer set” of FDA drugs for ERα, the Glide docking procedure was repeated with atom-pair similarity. This method significantly enriched the number of active compounds in the top 20 positions.

Finally, since these three procedures are receptor-centric, the ligand-centric approach was added to the last procedure to see if the combined receptor-ligand centric method would result in maximal enrichment. That is, the ligand-based descriptor similarities to the reference ligand were incorporated, as well as probe ligand-to-reference ligand and probe ligand-to-ligand pocket shape (protein binding site) similarities, to the docking score of the refined molecule database with atom-pair similarity. Computed values of all the receptor- and ligand-centric results unique to the TMFS method were applied to solve comprehensive score ‘Z’ (equation 1). The resulting top 20 rankings from each of these four procedures were plotted on a receiver operator curve (ROC).

From the ROC (FIG. 2A), the effect of the prediction method on the enrichment of true-positives over false-positives was determined. In comparison to individual descriptor approaches (i.e., ligand-centric or shape descriptors only), this combined approach showed the greatest enrichment of active compounds versus decoys, and served to validate the method.

While the ROC enrichment performance analysis was performed on a single instance of the DUD, the purpose of using this well-established target (ERα) was for a proof-of-concept for our TMFS approach. As will be explained in the subsequent section, the application of TMFS to the 2335 human protein crystal structures is to validate our method across the largest and most diverse data set we could obtain. In fact, the protein target set included 21 out of the 40 total DUD targets to date with respect to protein nomenclature.

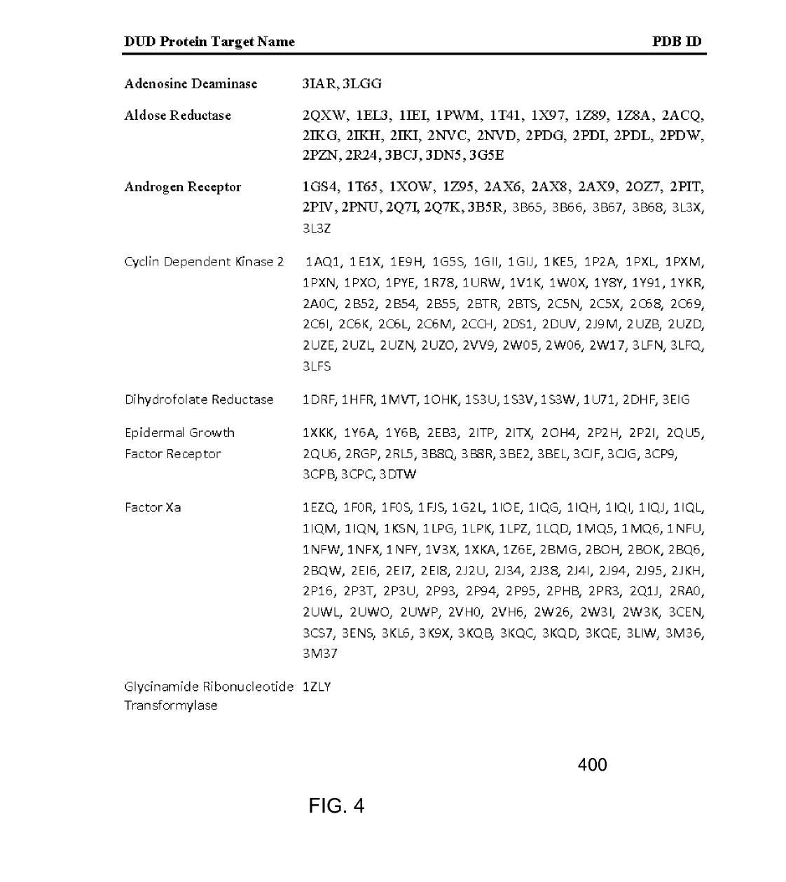

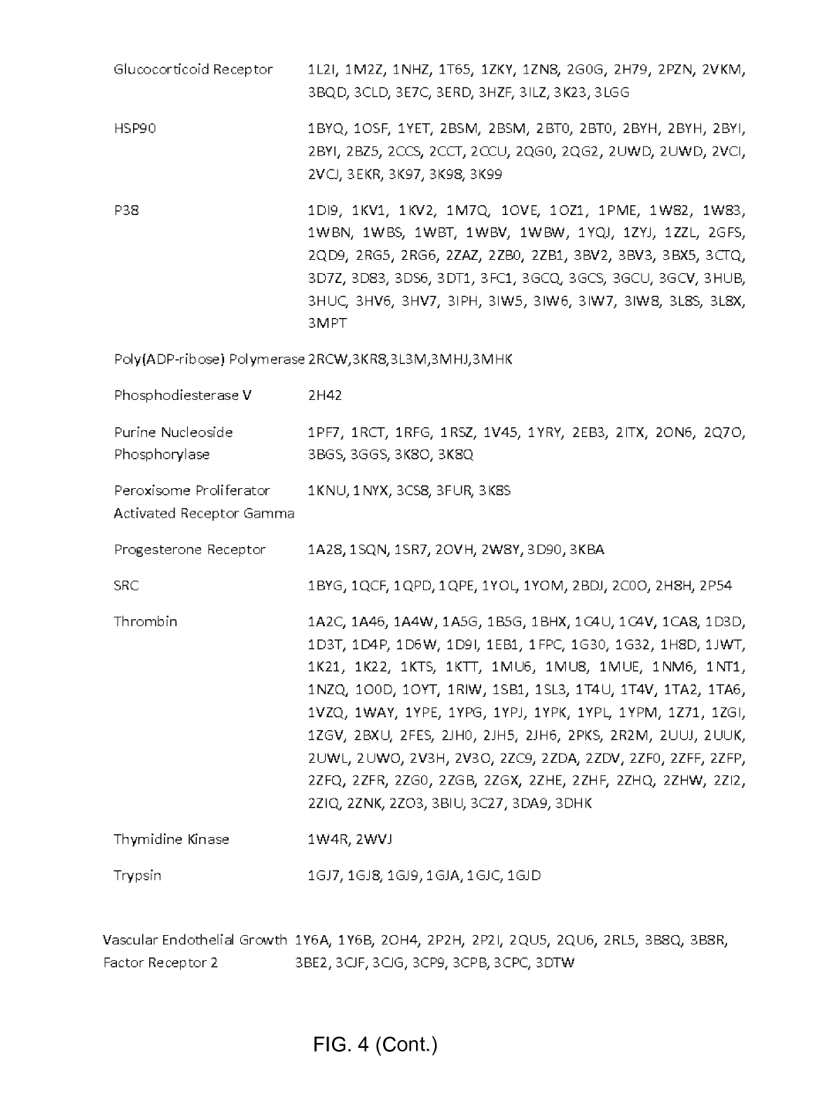

Furthermore, as depicted in table 400 of FIG. 4, our protein target set also includes many different instances of those DUD targets. For example, PPARγ is represented in our protein target set through five unique PDB crystal structures: 1KNU, 1NYX, 3CS8, 3FUR, and 3K8S. Although ROC enrichment performance analyses were not conducted for these other DUD targets, they are included in the large validation, which contributed to the final accuracy score (see next section). We therefore found the incorporation of these DUD targets in this fashion to be of greater value for our validation than a smaller number of individual ROC comparisons.

B. Validation Using Publically Available Literature

To validate predicted drug-target signatures, manual, structural, and automated text curation were used to exhaustively search DrugBank, BindingDB, ChemBL, PubChem, PDSP, and other published literature where experimental binding/functional data are available for FDA drugs. Since the drug data sets are associated with the drug bank ID, the most recently updated “drugcard” from DrugBank was used, which included information for each drug with respect to their targets and PDB IDs if available. This file was parsed into individual “drugcards” that correspond to each individual compound in the database.

DrugBank ID/PDB ID combinations were subsequently taken for each FDA molecule found in the top 1 through top 40 lists for each target and searched for matches across every individual “drugcard.” A successful prediction for every match occurrence was recorded and the data was annotated to the corresponding drug in the top 1, top 10, top 20, top 30, and top 40 ranked lists. Then we used “significance analysis” (eq 9) to obtain the percent correctly predicted (PCP) drug-target signatures. A similar procedure was used to curate and validate other experimental bioassay databases (see following section).

One caveat of this approach is that this validation method only contains a subset of the overall potential successful predictions. This is because many of the predicted hits have not been tested experimentally. Some of the hits listed in the databases are not included in our target data sets. Although a protein target may have many crystal structures deposited in the PDB, experimental data sources report only a single PDB ID for a target associated with a drug. To our knowledge, there is no reconciliatory method in the PDB to match PDB IDs to a single protein name, since each PDB file contains a different variation of the target name. In other words, we were unable to aggregate all the PDB IDs for a single protein target. It may be possible to perform a “fuzzy” text search.

In addition our FDA-approved drug database is only a subset (54%) of the entire DrugBank database, which results in a skewed representation of this validation process. Similarly, we do not have all of the PDB IDs that are found in the entire DrugBank database. This is because our final protein target database was contingent upon our compiled target data set of 2335. Furthermore, we have not included universal target binding component proteins such as the multidrug resistant (MDR) protein cytochrome p450. These caveats pose an interesting challenge in performing an optimal validation check. To address these concerns in the validation, we have developed a statistical procedure specifically for this kind of validation task (equation 9) calculates the percent correctly predicted (PCP) targets.

FIG. 3B shows the validation of predicted drug-target associations for FDA approved drugs. Predicted drug-target associations for each FDA drug in the Top 1 through Top 40 ranked hits were individually matched against the publically available experimental binding and functional data. Percent Correctly Predicted (PCP) targets were then calculated using equation 9 for each category of the top rank lists (i.e. Top 1 to Top 40). The histogram (filled bars) represents the Percent Correctly Predicted (PCP) targets (y-axis) for each category of top rank lists. Error bars as well as percentages are highlighted on each histogram bar.

We repeated the structural and automated text curation to exhaustively search DrugBank, BindingDB, ChemBL, Pub-Chem, PDSP, and other published literatures. FIG. 3B depicts the percentage of targets correctly predicted by the TMFS method across all the databases. To obtain this percentage, we counted the number of matched and unmatched pairs and also determined the excluded/included missing targets in terms of their protein target name, drug name or structure, or PDB code. Then we substituted this number in eq 9. This number was used as the total possible validations for each drug. Upon analysis of the results and validation generated using eq 9, we reliably reproduced many experimentally validated drug-target associations (FIG. 3B).

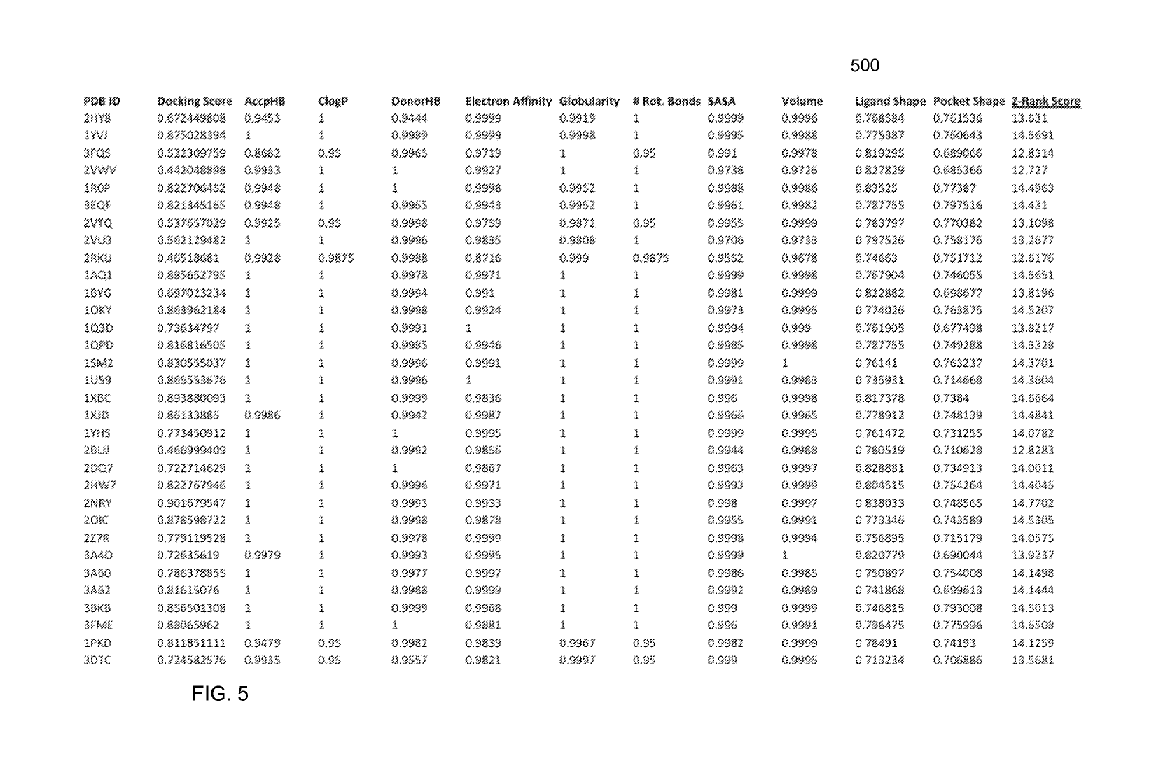

We achieved >91% correct predictions for the majority of drugs. A classical example of some of the literature-validated (>95% target hits) include staurosporine, genistein, paricalcitol, ethoxzolamide, alitretinoin, and drospirenone. The first ranked drug for each target is 58.5% correctly predicted followed by 65%, 77%, 85%, and 91% for the top 10, 20, 30, and 40, respectively (FIG. 2B). Prediction of a first-ranked drug is more sensitive to descriptor prediction value error such that a slight variation in the descriptor error will affect the correct prediction. For reference, we have included the data for all top-ranked staurosporine-protein target interactions in table 500 of FIG. 5. In contrast, ranking within the top 40 is the least sensitive, and this error is more or less balanced. This is quite remarkable considering the completely in silico nature of the screening and the experimental vagaries for many of the interactions.

FIG. 5 shows raw score values for each descriptor and Z-rank score for protein targets that were considered to be the Top 1 hit for staurosporine (DB2010) according to embodiments of the present invention. Furthermore, each protein-ligand complex has a line similar to those below (not shown). Thus, it can be extrapolated that the raw data of all protein-ligand interaction permutations total to 2,335 targets×3,671 ligands=8.204.685 lines of descriptor scores.

C. Performance of the TMFS Method

To determine how well the receptor- and ligand-centric component descriptors (11 in total) correlate in obtaining a reliable prediction of hits for a given protein target, a principle component analysis (PCA) was performed. The data set for PCA included the normalized descriptor values for the top 40 hits with respect to their predicted targets (n=2,335). To reduce the dimensionality of the data, a ‘scree plot’ was first performed to determine how many principle components explain most of the variance in the data.

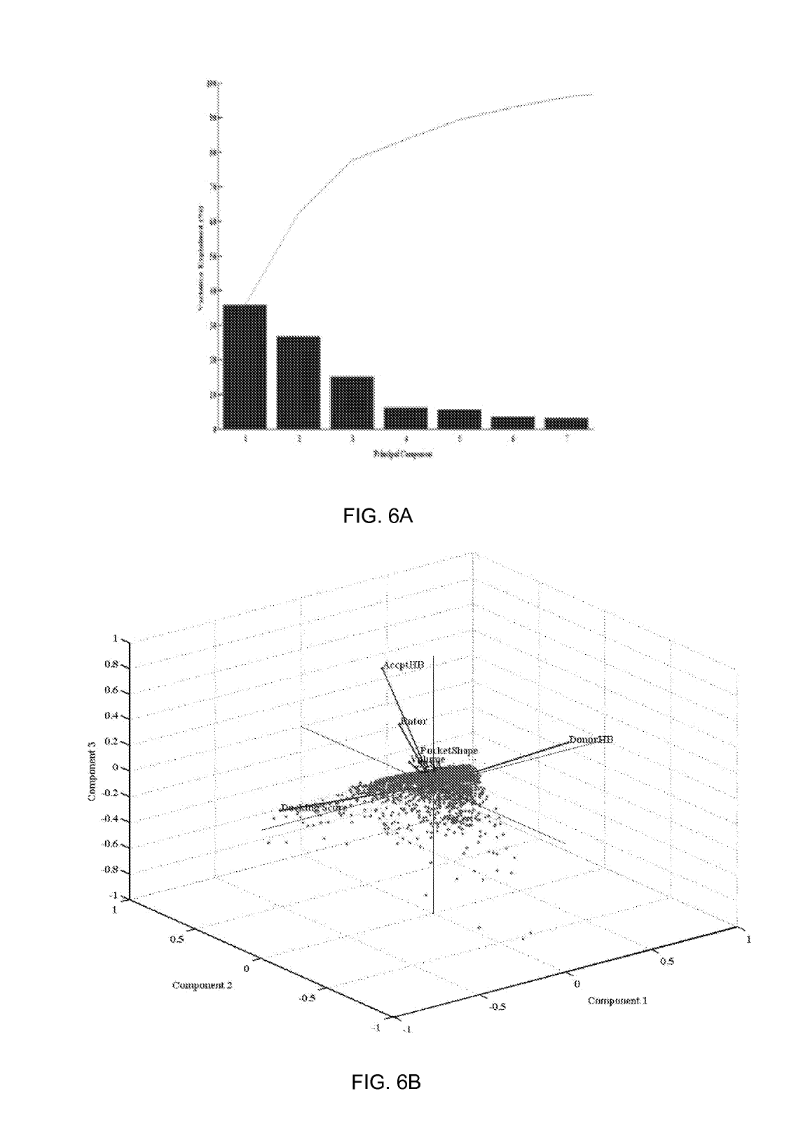

FIG. 6 is a principle Component Analysis (PCA) of individual protein- and ligand-based descriptor variables for determination of descriptor correlation with obtaining reliable predictions. The figure shows a Scree plot depicting the first three principal components accounting for the majority of the data variance. The first three principle components accounted for approximately 76% of the data variance.

Thus, the transformed Eigen value coefficients of the above descriptors were plotted against the first three principle components (FIG. 6B). FIG. 6B shows a three-dimensional PCA plot of transformed eigenvalue coefficients of the aforementioned descriptor variables against the first three principal components. The red dots represent individual descriptor observations (i.e. normalized score for each protein- and ligand-based descriptor variable), and corresponding vectors are shown as black arrowheads whose direction and length indicate how that variable contributes to the three principal components.

All descriptors, with the exception of docking score and hydrogen bond donor (DonorHB), exhibit a positive correlation across all three components. This implies that most of the ligand-centric descriptors and ligand/protein-centric shape descriptors correlate well with each other in determining a “molecule of good fit” for a given target. Furthermore, the docking score descriptor deviates from the rest of the descriptors. In other words, the protein-ligand complex that has the lowest-energy pose is not necessarily (or even likely to be) the one with the best fit. The docking score can be a raw energetic term that takes into account the energetics of interactions between a ligand and protein, and in which, important parameters such as, solvent, entropy and enthalpy are absent. In contrast, embodiments can include protein and ligand topology descriptors in addition to energetic terms. Hence, a reliable prediction algorithm can benefit from a comprehensive approach that takes into account both receptor- and ligand-centric descriptors.

### VI. Analysis of Drug-Target Associations

A. Drug Frequency Propensity

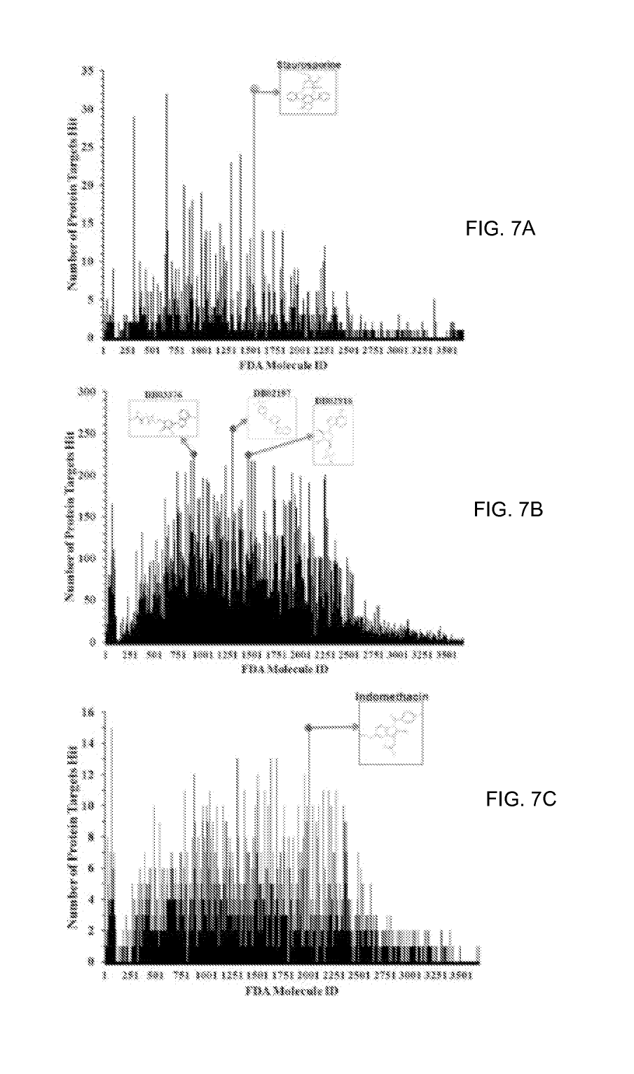

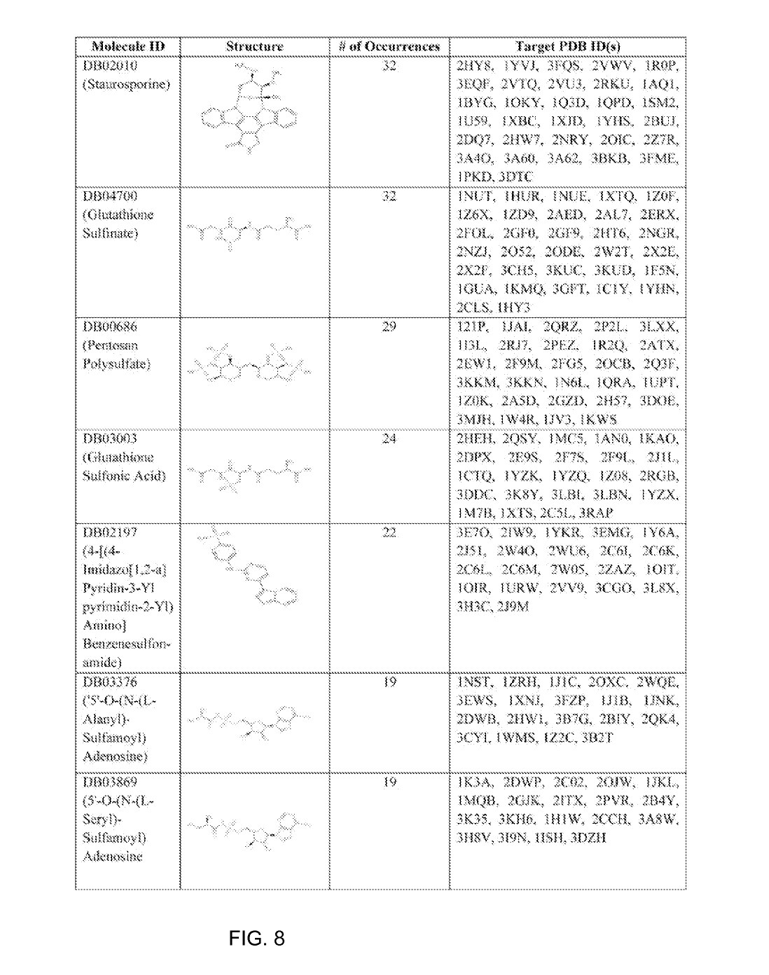

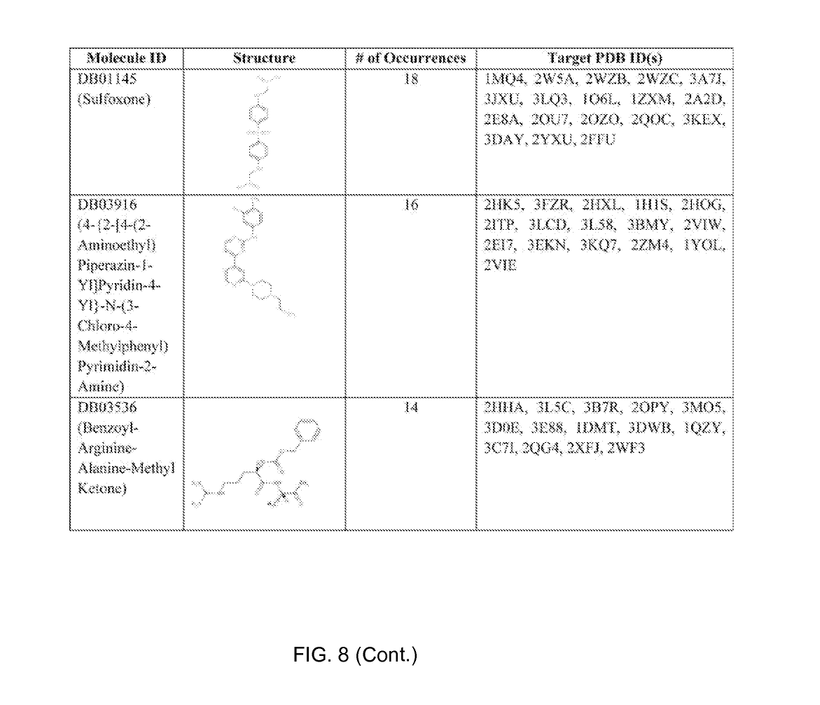

We predicted drug-target associations were analyzed (FIG. 7A-7C and FIG. 8) in terms of drug frequency propensity for each target (i.e., drugs that interact with multiple targets with potentially good or bad effects). If a side effect is desirable, the drug might be repurposed for an additional indication. Targets are considered as hits if the TMFS rank places it in the top 1 (FIG. 7A) to top 40 (FIG. 7B). The broad-spectrum kinase inhibitor staurosporine was predicted to hit the most protein targets in the top 1 position. This finding is consistent with previous reports that staurosporine is a prototypical ATP-competitive multi-kinase inhibitor, and 8% of the PDB data set comprised of kinase like structures. Some clinical drugs with IDs denoted by drug bank DB02197, DB02916, and DB03376 are also predicted to hit many targets in the top 40 (FIG. 7B). These structures are also ATP-like. In addition, the PDB database is biased toward kinases, and many kinase structures are co-crystallized with ATP, GTP or closely-related analogues. In an effort to further enrich the prediction paradigm, an RMSD term for ligand shape was included, where the RMSD of the docked ligand is compared to the active conformation of the co-crystallized ligand. Since this was a computational-intensive process, 100 protein targets were randomly chosen. In this case, indomethacin, a non-steroidal anti-inflammatory drug was predicted to hit the highest number of protein targets in the top 1 and top 40 rankings (FIG. 7C).

FIGS. 7A-7C contains an analysis of FDA Drug-Target Association. Frequency histograms are shown depicting the number of protein target hits (y-axis) for each FDA drug (x-axis). Targets are considered hits for a particular molecule if the final ranking (Z-score) of the molecule places it in the Top 1 position, or somewhere in the Top 40 positions. (A) Frequency histogram depicting the number of protein targets hit y-axis for each FDA drugs (x-axis) in the Top 1 position. The 2D structure of staurosporine, the drug with the most hits, is also displayed. (B) Frequency histogram depicting the number of protein target hits (y-axis) for each FDA drug (x-axis) in the Top 40 position. The Top 40 provides a more relaxed criterion for protein targets to be considered as hits. As such, those molecules that survive the final cut-offs and are found in the Top 40 rank list for a particular protein are predicted to have a good potential to bind to that given target. DB02197, DB03376, and DB02916, drugs with the most predicted hits, are depicted. (C) To further enrich the prediction paradigm, a term corresponding to ligand shape was included. The value for this term is the RMSD of the docked ligand compared to the active conformation of the co-crystallized ligand for a particular protein crystal structure, which is derived from a set of 100 protein targets. The histogram portrays the frequency of hits of each FDA drug along with the 2D structure of the drug with most target hits (Indomethacin).

B. FDA Blockbuster Drug-Target Associations

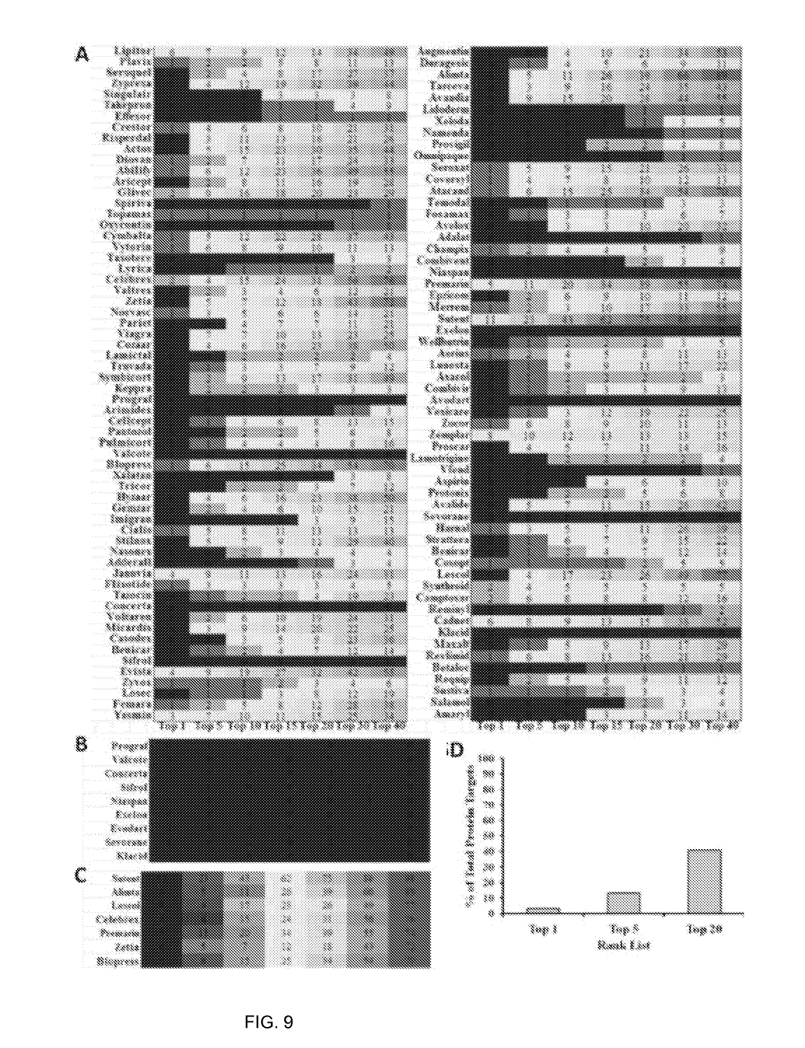

Next, top 200 “blockbuster” drug-target associations were predicted, and their frequency of occurrence across the 2,335 human protein targets within top 1 to top 40 hits (FIG. 9A) was determined. Several “blockbuster” drugs were predicted to target proteins across multiple families. Sutent was predicted to hit the greatest number of protein targets followed by Alimta. Lescol, Celebrex, Premarin, Zetia, and Blopress (FIG. 9B). Sutent, the drug predicted to be the most promiscuous, is a multi-kinase inhibitor prescribed to treat various cancers. Remarkably, Prograf, Valcote, Concerta, Sifrol, Niaspan, Exelon, Evodart, Sevorane, and Klacid have no hits in the protein dataset (FIG. 9C).

Out of 2,335 targets, a blockbuster drug is ranked first for 79 (3.2%), for 243 targets (10.9%) a blockbuster drug is ranked in the top five, and for 816 targets (36.5%) a blockbuster drug is ranked in the top 20 (FIG. 9D). 96 targets (4.3%) were predicted to bind to three or more “blockbuster drugs” (FIG. 9D). Taken together, these results imply either toxicity by cross target effects or potentially beneficial effects that might indicate new uses. In addition to utility in drug repurposing, these data also provide clues for the synthesis of analogues with higher specificity for particular targets.

C. Drug Promiscuity and Overlap of Protein Family and Fold

In drug development, it is important that molecules reach and interact with their desired targets while minimizing cross-target interactions. However, many FDA approved drugs have notable side effects about which consumers are warned prior to their administration. Thus, it was determined whether the described method could be used to more formally predict the extent of drug promiscuity/non-specificity. The extent of promiscuity was evaluated in terms of protein family and fold classification. The entire SCOP database was used and parsed to create a CSV file that matches the PDB IDs with their corresponding fold and family keys.

Then, for each molecule in the drug data set, the targets were determined for which they are considered the top 1 hit and those PDB IDs were used to determine the folds and families they correspond to. Using this information, the numbers of unique folds and families that the drugs are targeting were determined. To objectively quantify the “promiscuity” of a molecule, a numerical score was devised to create the “value of promiscuity.” This value is the combined sum of the number of unique folds and the number of unique families that a particular molecule is predicted to hit. The greater this value, the greater the extent of promiscuity.

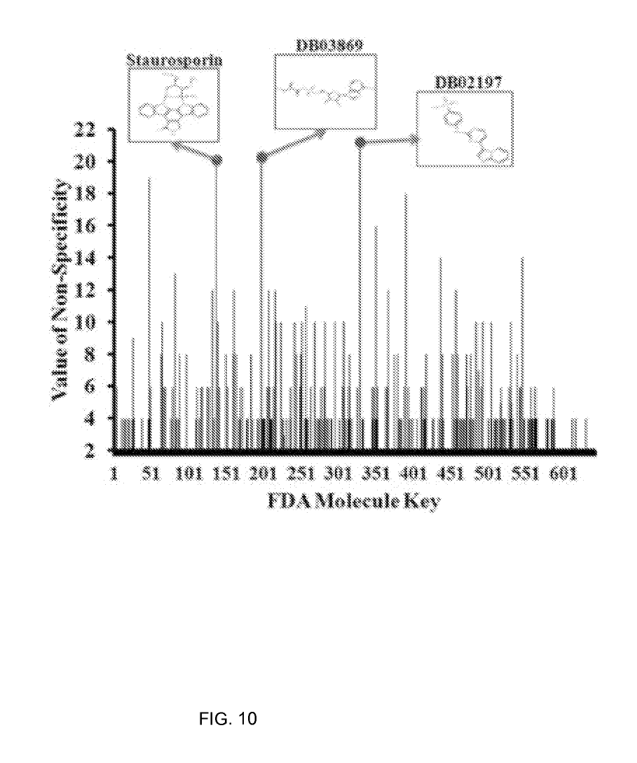

FIG. 10 contains an analysis of drug promiscuity. The “value of promiscuity (non-specificity) for each drug is represented as a numerical score from the combined sum of the number of unique folds and the number of unique families that a particular molecule is predicted to hit. The drug with the greatest “value of non-specificity” is considered to be the most promiscuous molecule. The histogram depicts the “values of non-specificity” (y-axis) for each drug (x-axis) that had been ranked in the top 1 position, along with the 2D structures of the three most promiscuous compounds.

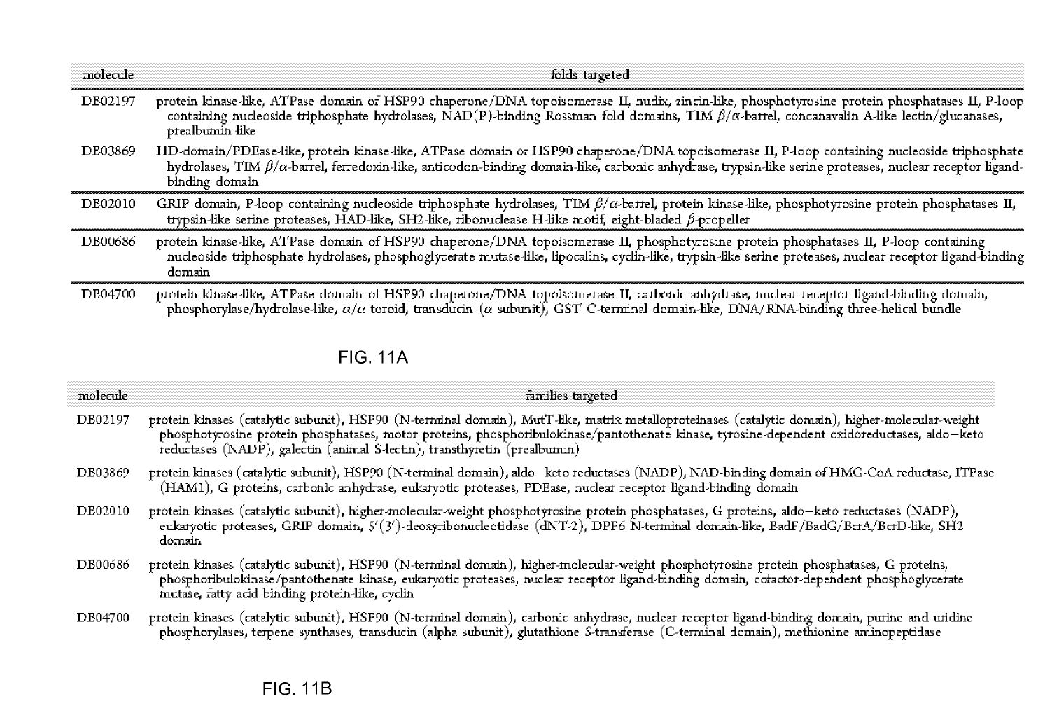

As seen in FIG. 10, the three most promiscuous compounds (DB02197, DB03869, and staurosporine) are kinase inhibitors. As indicated above, staurosporine is a “broad-specificity kinase inhibitor” targeting multiple families especially kinases. Furthermore, FIGS. 11A and 11B show that the five most promiscuous drugs are predicted to interact with proteins that have many overlapping folds/families.

D. Similarly Shaped Protein Pockets Bind Similarly Shaped Molecules

In drug development, it is commonly asked if protein targets with similar binding sites bind similar molecules. However, given the central dogma of “form fits function”, it is usually acceptable to assume this. To determine the similarity of binding sites between proteins, the Euclidean distances were calculated between the spherical harmonics (SH) expansion coefficients of the binding pockets at a 6 Å radius from neighboring residues from the sc-PDB database and SurFlexDock within SYBYL X. These protomols provide a space-filled 3-D structure of the binding sites using carbon, hydrogen, and oxygen atoms.

To get a more refined sense of the pockets, the oxygen atoms were removed because of their large atomic radii, and the SH calculations were performed on the remaining carbon and hydrogen atoms. With the binding pocket shapes quantified, the Euclidean distances were then calculated between target binding pockets in which each target was taken as a template pocket and Euclidean distances were calculated against all the other probe target binding pockets. The most similar pockets were those whose Euclidean distances were closest to zero.

Then, to determine if similarly-shaped pockets bind similar molecules, three approaches were taken. First, drugs DB2010 (staurosporine) and DB02197 (the most frequent hits using the Top 1 and Top 40 rankings, respectively) were taken, and it was determined if the number of proteins with similarly shaped binding sites was greater than that of those with lesser similarity.

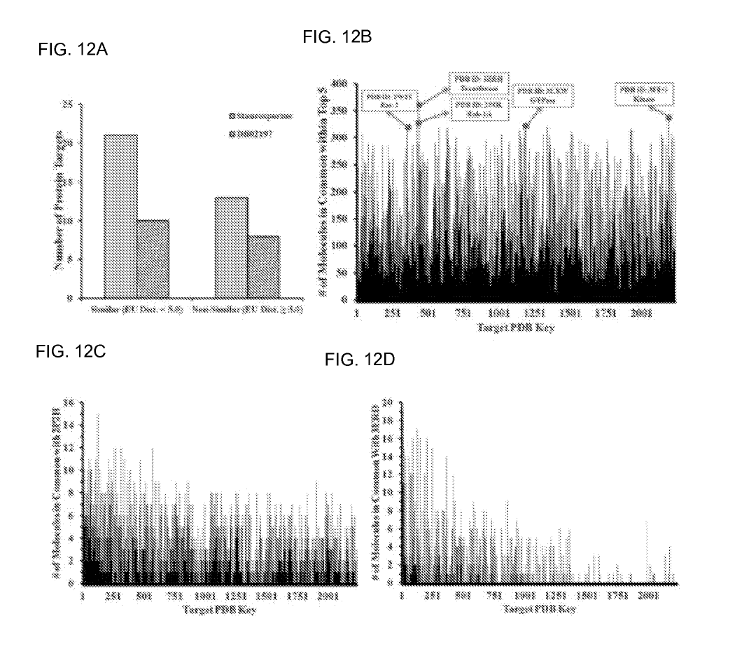

FIGS. 12A-12D show that similarly-shaped protein binding pockets bind similar molecules. (A) shows a histogram where the left-most protein target on the X-axis corresponded to the protein target whose pocket was most similar to the template. If these histograms tapered off to the right, this indicates that protein target ligand commonality is highly correlated to the three-dimensional spatial similarity of their binding pockets. (B) shows the commonality of the top-ranked drugs. The predicted top 5 ranked drugs were counted for each target. Commonality is defined as the number of times a molecule from the top-rank list for a reference protein target also shows up in the corresponding top-rank list for the rest of the targets. The histogram depicts the “commonality score” for molecules within the Top 5 rank list for each protein target data set. The top 5 protein targets, (with respect to commonality score), which were co-crystallized with a nucleotide (4 out of 5 are GDP, one is adenosine), are highlighted with their PDB codes and name. (C) shows a histogram depicting the number of molecules in common for all protein targets ordered from greatest to least with respect to pocket shape similarity to VEGFR2. (D) shows a histogram depicting the number of molecules in common for all protein targets ordered from greatest to least with respect to pocket shape similarity to ERα.

FIG. 12A is a clustered histogram illustrating this relationship, and shows that more similarly shaped pockets exist for both drugs. Second, the number of targets that intersect with the top five reprofiled drugs for each target was determined. This intersection was defined to be the number of times a top five profiled-drug for a reference target also appears in the top five rank lists with respect to the rest of the targets. It was found that many targets have drugs that are common across the total protein data set (FIG. 12B).

Third, the estrogen receptor alpha protein (PDB ID: 3ERD) and vascular endothelial growth factor receptor (PDB ID: 2P2H) binding pocket commonality with respect to the 2.335 targets (FIGS. 12C and 12D) was analyzed. Euclidean distances of 2,335 target pockets were calculated against these two template pocket structures. The number of the top 20 ranked molecules for each protein target that were common to each template was subsequently calculated. It was found that those pockets with the greatest shape similarity have the greatest number of drug hits in common with the templates (FIGS. 12C and 12D). These results suggest that similarly shaped protein pockets bind similar molecules and indicate that a drug can be repurposed to other indications based in part upon similarly shaped targets.

### VII. Experimental Validation

As described above, embodiments can provide a computational method (some embodiments called “TMFS”) that includes a docking score, ligand and receptor shape/topology descriptor scores, and ligand-receptor contact point scores to predict “molecules of best fit” and filter out most false positive interactions. Using the TMFS method, we reprofiled 3671 FDA approved/experimental drugs against 2335 human protein targets. We predict several drug-target associations that could potentially be applied to new disease indications.

Literature validation using public databases reveals that the TMFS method predicts drug-target associations with greater than 91% accuracy for the majority of drugs. We predict and experimentally validate that the anti-hookworm medication mebendazole can inhibit VEGFR2 activity and angiogenesis and that the anti-inflammatory drug celcoxib and its analogue DMC can bind to CDH11, a biomolecule that is very important in rheumatoid arthritis and poor prognosis malignancies and for which no targeted therapies currently exist. TMFS-predicted drug-target associations not only reveal potential drug candidates for new indications but also provide structural insight into their mechanism of action and crosstarget effects.

A. Mebendazole Hinds to VEGFR-2, and Inhibits Angiogenesis

The VEGFR2 kinase assay was performed by using the Caliper LabChip 3000 and a 12-sipper LabChip. LabChip assays are separations-based, wherein the product and substrate are electrophoretically separated, thereby minimizing interference and yielding high data quality. Z′ factors for both the EZ Reader and LC3000 enzymatic assays are routinely between 0.8 and 0.9. The off-chip incubation mobility-shift kinase assay uses a microfluidic chip to measure the conversion of a fluorescent peptide substrate to a phosphorylated product. The reaction mixture, from a microtiter well plate, is introduced through a capillary sipper onto the chip, where the nonphosphorylated substrate and phosphorylated product are separated by electrophoresis and detected via laser-induced fluorescence. The signature of the fluorescence signal over time reveals the extent of the reaction. The precision of microfluidics allows for the detection of subtle interactions between drug candidates and therapeutic targets.

The assay reaction is: Fluorescein-peptide+ATP→fluorescein-phosphopeptide+ADP, which is measured by charge separation of phosphorylated product and unphosphorylated substrate. The assay incubation is carried out in 100 mM HEPES (pH 7.5), 10 mM MgCl2, 1 mM DTT, 0.05% CHAPSO, 1.5 uM peptide substrate, 450 uM ATP, nine different concentrations of Mebendazole, and Staurosporine used as the positive control. Following addition of ATP, samples were incubated for 60 minutes at room temperature and the reaction was terminated by the addition of stop buffer containing 100 mM HEPES (pH 7.5), 7 mM EDTA, 0.015% Brij-35, 4% DMSO. Phosphorylated product and unphosphorylated substrate were separated by charge using electrophoretic mobility shift. The product formed is compared to control wells to determine inhibition or enhancement of enzyme activity.

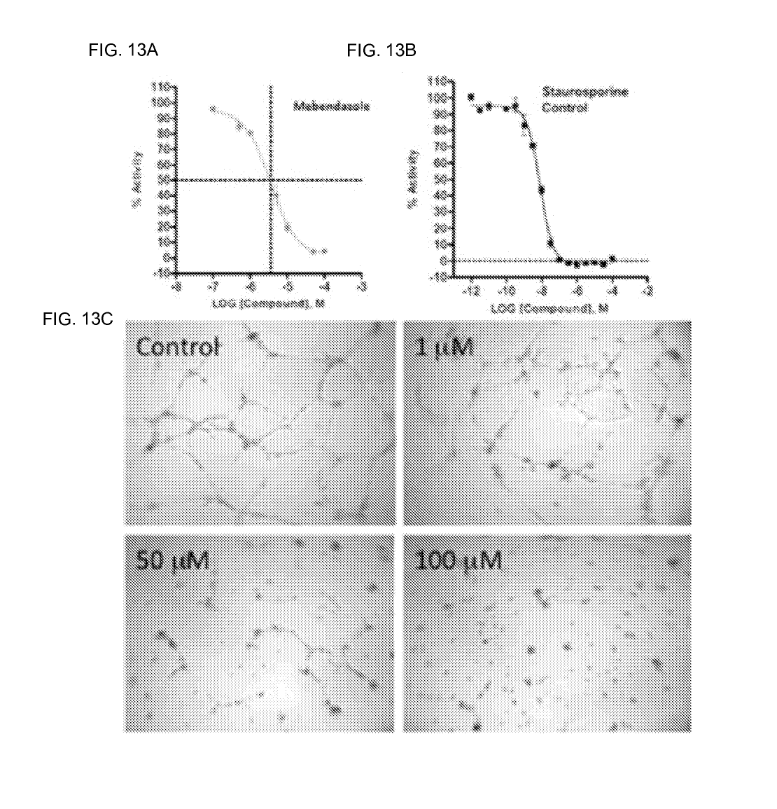

FIGS. 13A-13C demonstrate that Mebendazole binds directly to VEGFR2 kinase assay and also inhibits angiogenesis. (A) Mebendazole binds directly to VEGFR2 and affects VEGFR2 kinase activity with an IC50 value of 3.6 μM. IC₅₀ curves were generated using GraphPad 5 and a standard 4-parameter non-linear regression model (log [inhibitor] vs response−variable slope). Data points correspond to the averages of duplicate wells, and error bars represent the mean±replicate % activity. The graphical representation shows dashed lines at the IC₅₀ values, where the vertical line is at (log x)=−5.4437. Solving the equation (log x)=−5.4437 results in the IC50 value of 3.6 μM. (B) Control: Staurosporine binds to VEGFR2 and affects kinase activity with an IC₅₀ value of 8 nM. (C) Mebendazole, predicted to act as a VEGFR2 inhibitor by TMFS, inhibits angiogenesis in a HUVEC cell based assay. Mebendazole significantly inhibited network formation with an IC₅₀ value of 8.8 μM, which is implicated by the lack of cellular migration, alignment, and branching.

The TMFS method described herein predicted that Mebendazole, an anti-parasitic with unexpected anti-cancer properties in animals and humans, had a strong likelihood of binding to and inhibiting the function of VEGFR2. Indeed, in-vitro studies show that Mebendazole binds to VEGFR-2 and inhibits kinase activity at 3.6 μM (FIG. 13A), with a staurosporine as a control (FIG. 13B).

B. Angiogenesis Assay

Mebendazole was dissolved in 50 μl of DMSO and diluted with endothelial growth medium (EGM) to a final concentration of 1 mM. The highest concentration of DMSO is 0.1%. Human umbilical vein endothelial cells (HUVEC) were purchased from Cambrex Co. (East Rutherford, N.J., USA) and maintained in endothelial growth medium (EGM) supplemented with 2% FBS, 0.1% EGF, 0.1% hydrocortisone, 0.1% GA-1000, and 0.4% BBE. Morphogenesis assay on Matrigel was performed according to the manufacturer's instructions (Chemicon International). The ECMatrix™ kit consists of laminin, collagen type IV, heparan sulfate, proteoglycans, entactin, and nidogen. It also contains various growth factors (TGF-beta, FGF) and proteolytic enzymes (plasminogen, tPA, and MMPs) that are normally produced in EHS tumors. The incubation condition was optimized for maximal tube-formation as follows: 50 μl of EC Matrix™ was suitably diluted in a ratio 9:1 with 10× diluent buffer and used to coat the 96-well plate. The coated plates were incubated at 37° C. for 1 hr to allow the Matrix solution to solidify. HUVECs were cultured for 24 h in EGM with 2% FBS, trypsinized and re-suspended in the growth medium. After 1 h pre-incubation of the plate with Matrix solution, the HUVECs were plated at 5×10⁵ cells/well in the absence or in the presence of Mebendazole (1-100 μM). After 24 h of incubation at 37° C., the three-dimensional organization (cellular network structures) was examined under an inverted photomicroscope. Each treatment was performed in triplicate.

It was also found that Mebendazole blocks angiogenesis in a human umbilical vein endothelial cell (HUVEC) based angiogenesis functional assay. The efficiency of Mebendazole to inhibit the VEGFR2 kinase was measured by monitoring the ability of HUVECs to form networks. In the HUVEC angiogenesis assay, formation of the cellular network progresses in a stepwise manner with an initial migration, an alignment of cells, development of capillary tube-like structures, sprouting of new branches, and finally formation of cellular network. Cells treated with Mebendazole did not migrate and align, sprout branches or form networks (FIG. 13C) with an IC50 of 8.8 μM. Albendazole, a close analog of Mebendazole, was previously demonstrated to inhibit angiogenesis (44-46). In both assays, Mebendazole is active at a concentration similar to that approved for use to prevent hookworm infection.

C. Celecoxib Binds to Cadherin-11 (CDH11)

Surprisingly, an anti-inflammatory cycloxgenase-2 inhibitor, celecoxib, and its COX-2 inactive analogue dimethyl celecoxib (DMC) were ranked as top hits for interaction with CDH11, an adhesion molecule important in the inflammatory disease rheumatoid arthritis and in several poor prognosis malignancies. Consistent with its known role as a COX-2 inhibitor celecoxib was rank-ordered number 1 for COX-2. Celecoxib is already in use as an anti-inflammatory agent in arthritis where its activity is not solely related to inhibition of COX-2. The ability of dimethyl celecoxib and celecoxib to bind CDH11 was assessed using Surface Plasmon Resonance. Both celecoxib and the closely related but inactive (w.r.t. COX-2 inhibition) dimethyl celecoxib interacted with CDH11 as measured by SPR.

For a Cadherin 11 Surface Plasmon Resonance (SPR) Assay, surface plasmon resonance experiments were carried out with a Biacore T100 equipped with a CM5 sensor chip. Briefly, mouse extracellular domain 1-2 (EC 1-2) C-terminally cysteine-tagged cadherin-11 recombinant protein was immobilized on flow cell (FC) 2 in HEPES Buffered Saline (10 mM Hepes, pH 7.4; and 150 mM NaCl, 3 mM CaCl2) using a thiol-coupling kit according to the manufacturer's protocol, resulting in immobilization levels of 4580 response units (RU). FC1 was only activated and inactivated and used as a reference. Celecoxib and dimethyl celecoxib stock solution was diluted to a final concentration of 200, 100, 50, 25, 12 uM and injected in 10 mM Hepes, 150 mM NaCl, 3 mM CaCl2, 1% DMSO and 0.5% P20. Each injection was repeated three times for 60 seconds. FC signals were deducted from FC2 for background noise elimination.

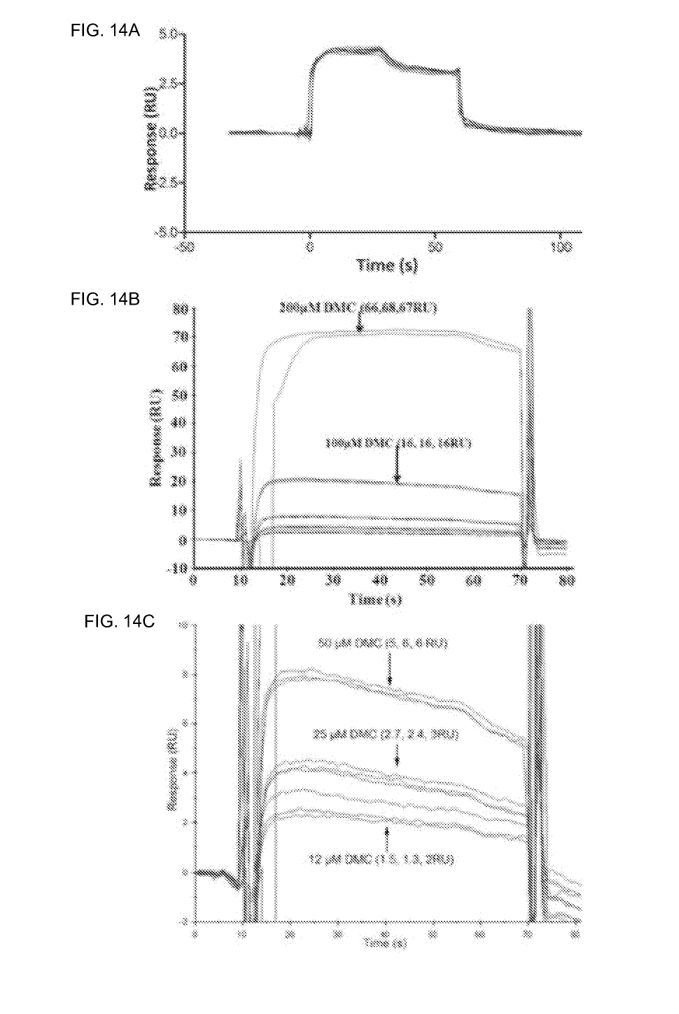

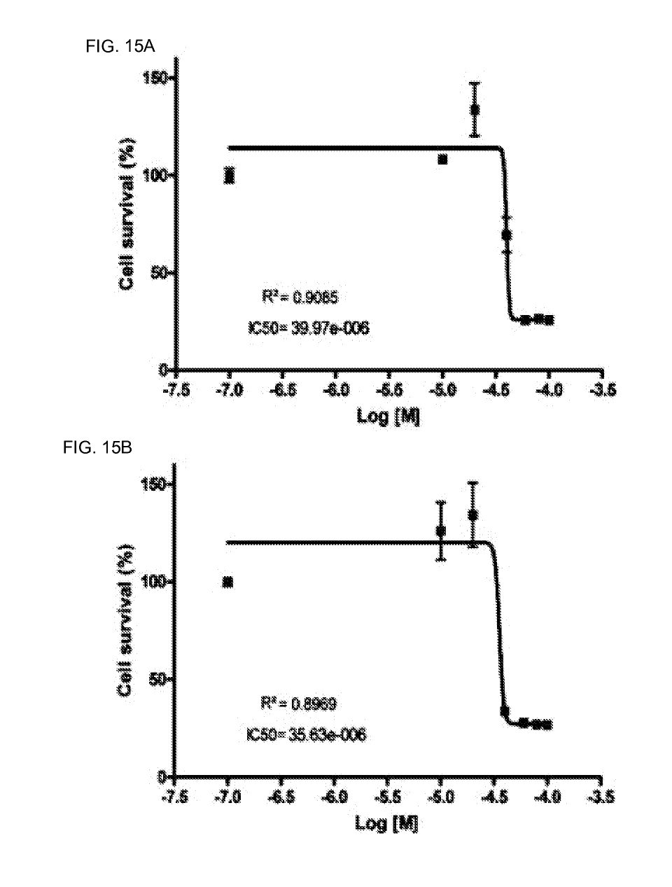

FIGS. 14A-14C show that Celecoxib (CCB) and Dimethyl-celecoxib (DMC) bind directly to immobilized cadherin-11 (CDH11) in Surface Plasmon Resonance (SPR) assay. (A) CCB and DMC bind to recombinant mouse extracellular domain (EC) 1-2 of CDH11 protein immobilized on the surface of the chip via similar patterns, as evident in the sensogram. CCB and DMC were separately injected three times on the CM5 chip at 25 μM. (B & C) CCB and DMC bind in a dose-dependent manner. (B) Lower magnification of the sensogram showing the signals generated from 200 and 100 μM of DMC bound to cadherin-11. (C) Higher magnification of the compacted signals from panel A showing the binding levels of 50, 25 and 12 μM DMC to cadherin-11. Assays were performed in triplicates for each DMC concentration.

D. Growth Inhibition of MDA-MB-231 Invasive Breast Cancer Cell Line Using MTS Assay

MDA-MB-231 cells were seeded at 4000 cells/well in a 96 well plate. Stock of celecoxib and dimethyl celecoxib were diluted in DMEM+10% FBS to make final concentrations used for treatment, and all concentrations were prepared to have the same amount of DMSO. Three wells per concentration were treated 24 h post seeding, and the MTS assay was performed 48 h post treatment. The CellTiter96 Aqueous Non-Radioactive Cell Proliferation Assay kit (Promega) was used according to the manufacturer's recommendations. The absorbance values were measured at 490 nm and viable cells presented as a percentage of the absorbance of DMSO-only treated cells. IC₅₀ and R² values were calculated with the Graphpad Prism software.

FIGS. 15A and 15B show the growth inhibition of MDA-MB-231 invasive breast cancer cell line by celecoxib (CCB) and its COX-2 inactive analogue dimethyl-celecoxib (DMC). The growth inhibition of the MDA-MB-231 invasive breast cancer cell line by celecoxib and DMC was calculated (FIGS. 15A and 15B). MTS assays demonstrating concentration-dependent cell growth inhibition when MDA-MB-231 cells were exposed to increasing doses of CCB or DMC for 48 hrs. Data is presented as the mean±S.E.M. (A) CCB causes inhibition with an IC50 of 40 μM, and (B) DMC causes inhibition with an IC₅₀ 36 μM.

It was found that celecoxib and DMC cause inhibition with an IC₅₀ of 40 μM and 36 μM, respectively. These findings correlate well with experimental and clinical studies where dimethyl celecoxib works as well as celecoxib, which points to a COX-2-independent mode of action. The measured IC₅₀'s of celecoxib and DMC are comparable to known celecoxib plasma concentrations in patients. Circulating levels in rats and in humans are in the 1-10 μM range for celecoxib and are not known for dimethyl celecoxib. Importantly, the Kd for the known celecoxib target Cox2 is in the low nanomolar range for in-vitro measurement of enzyme inhibition yet its effects on inflammation and cancer cell growth are in the micromolar range. Taken together with the fact that DMC has no effect on COX-2 yet is equally effective as an anticancer agent and in some cases as an anti-inflammatory, these discrepancies strongly point to a COX-2-independent mode of action. Though the affinity of dimethyl celecoxib for CDH11 is weak enough, this is a potential starting point for further optimization.

### VIII. Computer System

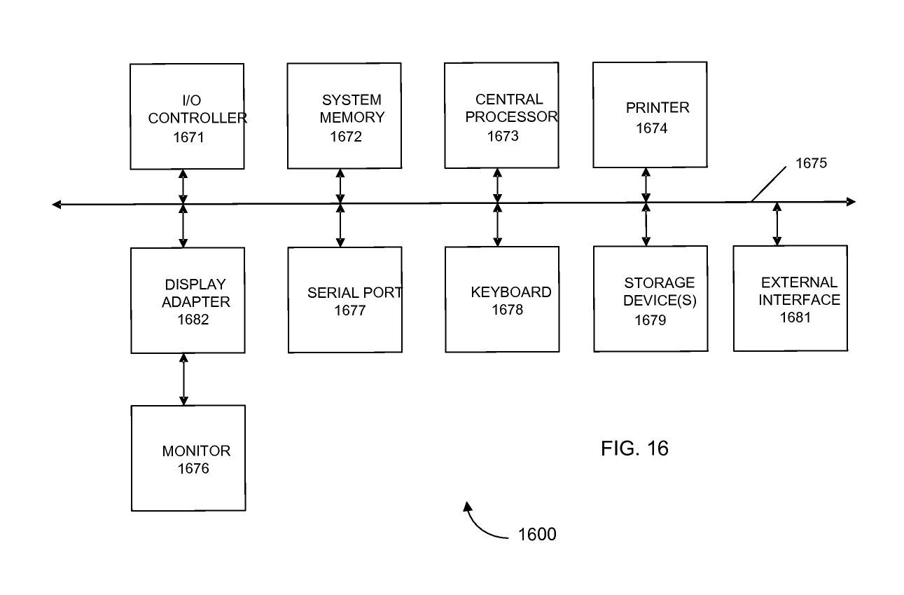

Any of the computer systems mentioned herein may utilize any suitable number of subsystems. Examples of such subsystems are shown in FIG. 16 in computer apparatus 1600. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 16 are interconnected via a system bus 1675. Additional subsystems such as a printer 1674, keyboard 1678, storage device(s) 1679, monitor 1676, which is coupled to display adapter 1682, and others are shown. Peripherals and input/output (I/O) devices, which couple to I/O controller 1671, can be connected to the computer system by any number of means known in the art, such as serial port 1677. For example, serial port 1677 or external interface 1681 (e.g. Ethernet, Wi-Fi, etc.) can be used to connect computer system 1600 to a wide area network such as the Internet, a mouse input device, or a scanner. The interconnection via system bus 1675 allows the central processor 1673 to communicate with each subsystem and to control the execution of instructions from system memory 1672 or the storage device(s) 1679 (e.g., a fixed disk, such as a hard drive or optical disk), as well as the exchange of information between subsystems. The system memory 1672 and/or the storage device(s) 1679 may embody a computer readable medium. Any of the data mentioned herein can be output from one component to another component and can be output to the user.

A computer system can include a plurality of the same components or subsystems, e.g., connected together by external interface 1681 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for identifying protein-drug interactions, the method comprising:
receiving test ligand molecular data corresponding to a test ligand that is a candidate drug;
receiving protein molecular data corresponding to a protein;
receiving reference ligand data corresponding to a reference ligand that binds to the protein;
calculating, by a computer system, a shape score including one or more shape contributions, each shape contribution corresponding to a respective shape descriptor, wherein a respective contribution includes two parts, the first part providing a first shape score from a first respective shape function of the protein and the test ligand corresponding to the respective shape descriptor, and the second part providing a second shape score from a second respective shape function of the reference ligand and the test ligand corresponding to the respective shape descriptor;
calculating, by a computer system, a similarity score including one or more similarity contributions, each similarity contribution corresponding to a respective similarity descriptor, wherein a respective similarity contribution provides a similarity score between a respective similarity function of the test ligand and the respective similarity function of the reference ligand;
calculating, by a computer system, a correction score, the correction score being a difference between two sums, the first sum being of energies of contact points between the reference ligand and the protein, the second sum being of energies of contact points between the test ligand and the protein; and
calculating an interaction score, the interaction score including a sum of the shape score, the similarity score, and the correction score.

2. The method of claim 1, further comprising:
normalizing the interactions score using weights for the first respective shape functions and the second respective shape functions.

3. The method of claim 2, wherein a normalization weight for a value where a best score is a maximum score is
$$N = \frac{x - min}{max - min} .$$

4. The method of claim 2, further comprising:
calculating a docking score between the test ligand and the protein; and
adding the docking score to the interaction score.

5. The method of claim 4, wherein a normalization weight for the docking score is
$$N = 1 - \frac{x - min}{max - min} .$$

6. The method of claim 4, wherein the interaction score Z for an lth test ligand and a pth protein is calculated using the formula:
$${Z}_{l , p} = {ω}_{k} Y ( {σ}_{p} , {σ}_{l} ) + {\sum }_{m = 1}^{M} [ {ω}_{m} {f}_{m} ( {σ}_{p} , {σ}_{l} ) + {ω}_{m}^{′} {f}_{i}^{′} ( {σ}_{c} , {σ}_{l} ) ] + {\sum }_{n = 1}^{N} {X}_{n} ( {σ}_{c} , {σ}_{l} ) + {CS ( O L I C )}_{l , p}$$

7. The method of claim 1, further comprising:
comparing the interaction score to a threshold to determine whether or not an interaction exists.

8. The method of claim 7, wherein the threshold is a score value.

9. The method of claim 7, further comprising:
determining an interaction score for a plurality of test ligand and protein combinations;
ranking the interactions scores; and
using a ranking as a the threshold.

10. The method of claim 1, wherein at least a portion of the reference ligand data is extracted from a known structure of a complex of the protein bound to the reference ligand.

11. The method of claim 1, wherein the one or more shape contributions include a Euclidean distance metric.

12. The method of claim 1, wherein the one or more similarity contributions include at least one of: a solvent-accessible surface area and a number of rotatable bonds.

13. The method of claim 1, wherein the first sum of the correction score for a jth protein is computed as: S(OLIC−R)ⱼ=Σₙ₌₁^{NR}ωₙE_{n,j}, where NR is a number of contact points between the reference ligand and the protein, ωₙ is a weighting factor for the nth contact point, and E_{n,j} is an energy associated with the nth contact point.

14. The method of claim 13, wherein the second sum of the correction score for an ith ligand and the jth protein is computed as: S(OLIC−T)_{i,j}=Σₙ₌₁^{NT}ωₙE_{n,i,j}, where NT is a number of contact points between the test ligand and the protein, ωₙ is a weighting factor for the nth contact point, and E_{n,i,j} is an energy associated with the nth contact point.

15. A computer product comprising a non-transitory computer readable medium storing a plurality of instructions that when executed control a computer system to identity protein-drug interactions, the instructions comprising: receiving test ligand molecular data corresponding to a test ligand that is a candidate drug;
receiving protein molecular data corresponding to a protein;
receiving reference ligand data corresponding to a reference ligand that binds to the protein;
calculating a shape score including one or more shape contributions, each shape contribution corresponding to a respective shape descriptor, wherein a respective contribution includes two parts, the first part providing a first shape score from a first respective shape function of the protein and the test ligand corresponding to the respective shape descriptor, and the second part providing a second shape score from a second respective shape function of the reference ligand and the test ligand corresponding to the respective shape descriptor;
calculating a similarity score including one or more similarity contributions, each similarity contribution corresponding to a respective similarity descriptor, wherein a respective similarity contribution provides a similarity score between a respective similarity function of the test ligand and the respective similarity function of the reference ligand;
calculating a correction score, the correction score being a difference between two sums, the first sum being of energies of contact points between the reference ligand and the protein, the second sum being of energies of contact points between the test ligand and the protein; and
calculating an interaction score, the interaction score including a sum of the shape score, the similarity score, and the correction score.

16. The computer product of claim 15, further comprising:
comparing the interaction score to a threshold to determine whether or not an interaction exists.

17. The computer product of claim 15, wherein the first sum of the correction score for a jth protein is computed as: S(OLIC−R)ⱼ=Σₙ₌₁^{NR}ωₙE_{n,j}, where NR is a number of contact points between the reference ligand and the protein, ωₙ is a weighting factor for the nth contact point, and E_{n,j} is an energy associated with the nth contact point. The method of claim 13, wherein the second sum of the correction score for an ith ligand and the jth protein is computed as: S(OLIC−T)_{i,j}=Σₙ₌₁^{NT}ωₙE_{n,i,j}, where NT is a number of contact points between the test ligand and the protein, ωₙ is a weighting factor for the nth contact point, and E_{n,i,j} is an energy associated with the nth contact point.

18. The computer product of claim 15, further comprising:
calculating a docking score between the test ligand and the protein; and
adding the docking score to the interaction score.

19. The computer product of claim 18, wherein the interaction score Z for an lth test ligand and a pth protein is calculated using the formula:
Z_{l,p}=ωₖY(σₚ,σₗ)+Σₘ₌₁^{M}[ωₘƒₘ(σₚ,σₗ)+ω′ₘƒ′ᵢ(σ_{c},σₗ)]+Σₙ₌₁^{N}Xₙ(σ_{c},σₗ)+CS(OLIC)_{l,p}.

20. The computer product of claim 15, further comprising:
normalizing the interactions score using weights for the first respective shape functions and the second respective shape functions, wherein a normalization weight for a value where a best score is a maximum score is
$$N = \frac{x - min}{max - min} .$$
